(19) United States
(12) Patent Application Publication
(10) Pub. No.: US 2024/0335747 A1
(43) Pub. Date: Oct. 10, 2024

(54) VIRTUAL IDENTIFIER PROCESSING METHOD AND APPARATUS, STORAGE MEDIUM, AND ELECTRONIC DEVICE

(71) Applicant: Tencent Technology (Shenzhen) Company Limited, Shenzhen (CN)

(72) Inventor: Jie XIAO, Shenzhen (CN)

(21) Appl. No.: 18/749,477

(22) Filed: Jun. 20, 2024

Related U.S. Application Data
(63) Continuation of application No. PCT/CN2023/097099, filed on May 30, 2023.

(30) Foreign Application Priority Data
Aug. 5, 2022 (CN) 202210940273.9

(51) Int. Cl. A63F 13/52; A63F 13/5372; A63F 13/5378; A63F 13/55; G06T 17/00

(52) U.S. Cl. CPC A63F 13/52; A63F 13/5372; A63F 13/5378; A63F 13/55; G06T 17/00

(57) ABSTRACT

This application discloses a virtual identifier processing method performed by an electronic device. The method includes: displaying a virtual scene including a first virtual character and a mini-map picture corresponding to the virtual scene; displaying a first location identifier on the mini-map picture where a second virtual character in the virtual scene is defeated, the second virtual character being a virtual character in a different camp from the first virtual character; and displaying a virtual item identifier on the mini-map picture where the second virtual character drops a virtual item set after being defeated, the virtual item identifier being configured for identifying a location of the virtual item set in the virtual scene. This application resolves a technical problem that efficiency of processing a virtual identifier is low due to a complex virtual identifier processing method in related art.

### CROSS-REFERENCE TO RELATED APPLICATIONS

This application is a continuation application of PCT Patent Application No. PCT/CN2023/097099, entitled “VIRTUAL IDENTIFIER PROCESSING METHOD AND APPARATUS, STORAGE MEDIUM, AND ELECTRONIC DEVICE” filed on May 30, 2023, which claims priority to Chinese Patent Application No. 202210940273.9, entitled “VIRTUAL IDENTIFIER DISPLAY METHOD AND APPARATUS, STORAGE MEDIUM, AND ELECTRONIC DEVICE” filed with the China National Intellectual Property Administration on Aug. 5, 2022, both of which are incorporated by reference in their entirety.

### FIELD OF THE TECHNOLOGY

This application relates to the field of computers, and specifically, to a virtual identifier processing technology.

### BACKGROUND OF THE DISCLOSURE

Currently, when a virtual character is defeated in a virtual scene, the defeated virtual character can only be indicated through text prompt information. When wanting to share a result obtained after defeating the virtual character, a user can only manually mark the result on an in-game map. By using the manner, at least the in-game map needs to be opened first, then a location of the defeated virtual character is manually determined and manually marked on the in-game map, causing complex sharing of a defeat result.

For example, after a distant teammate defeats a virtual character from another camp, perception of the user's on the defeated virtual character and a virtual item dropped after the virtual character is defeated is extremely weak. When actions of a team to which the user belongs are scattered, after a teammate defeats an enemy, a location of the virtual character defeated by the teammate can only be determined by using a voice broadcast and an identifier manually marked by the teammate on a map. After the virtual character is defeated, a reward is generally dropped at a location of the virtual character when being defeated. If the teammate does not mark manually, it is difficult for the user to quickly know the location of the reward dropped after the virtual character is defeated.

Therefore, there is a technical problem that efficiency of processing a virtual identifier is low due to a complex virtual identifier processing method in related art.

### SUMMARY

Embodiments of this application provide a virtual identifier processing method and apparatus, a storage medium, and an electronic device, to at least resolve a technical problem that efficiency of processing a virtual identifier is low due to a complex virtual identifier processing method in related art.

According to an aspect of embodiments of this application, a virtual identifier processing method is performed by an electronic device. The method includes:

displaying a virtual scene including a first virtual character and a mini-map picture corresponding to the virtual scene;

displaying a first location identifier on the mini-map picture where a second virtual character in the virtual scene is defeated, the second virtual character being a virtual character in a different camp from the first virtual character; and

displaying a virtual item identifier on the mini-map picture where the second virtual character drops a virtual item set after being defeated, the virtual item identifier being configured for identifying a location of the virtual item set in the virtual scene.

According to still another aspect of embodiments of this application, a non-transitory computer-readable storage medium is further provided. The computer-readable storage medium has a computer program stored thereon, and the computer program, when executed by the processor, causes the electronic device perform the foregoing virtual identifier processing method.

According to still another aspect of embodiments of this application, an electronic device is further provided, including a memory and a processor. The memory has a computer program stored therein that, when executed by the processor, causes the electronic device to perform the foregoing virtual identifier processing method by using the computer program.

In embodiments of this application, a virtual scene in which a first virtual character is located and a mini-map picture are displayed in a to-be-processed application. The mini-map picture is a mini-map picture corresponding to the virtual scene. A first location identifier is displayed on the mini-map picture if a second virtual character in the virtual scene is defeated. The second virtual character is a virtual character in a different camp from the first virtual character. The second virtual character is allowed to be defeated by a virtual character in a different camp in the virtual scene. The first location identifier is configured for identifying a location of the second virtual character when being defeated in the virtual scene, thereby facilitating quick determining of the location of the defeated virtual character based on the first location identifier. A virtual item identifier is displayed on the mini-map picture if the second virtual character drops a virtual item set after being defeated. The virtual item identifier is configured for identifying a location of the virtual item set in the virtual scene, thereby facilitating quick obtaining of the virtual item dropped by the defeated virtual character based on the virtual item identifier. The mini-map picture displays the location of the defeated virtual character and the virtual item dropped by the defeated virtual character, to facilitate a user quickly obtaining of the location of the defeated virtual character and information of the dropped virtual item set without need for the user to manually mark the dropped virtual item set, so that the virtual item set is quickly and effectively positioned to prevent the user from not being able to find loot after an enemy is defeated and needing active marking and the like. In this way, positioning time and analysis time of the user can be saved, and the user can view a virtual identifier efficiently, so that a technical effect of simplifying a virtual identifier processing method and improving virtual identifier processing efficiency is achieved, thereby further resolving a technical problem that efficiency of processing a virtual identifier is low due to a complex virtual identifier processing method in related art.

### BRIEF DESCRIPTION OF THE DRAWINGS

The accompanying drawings described herein are used to provide a further understanding of this application, and form a part of this application. Exemplary embodiments of this application and descriptions thereof are used to explain this application, and do not constitute any inappropriate limitation to this application. In the accompanying drawings:

FIG. 1 is a schematic diagram of an application environment of an optional virtual identifier processing method according to an embodiment of this application.

FIG. 2 is a schematic flowchart of an optional virtual identifier processing method according to an embodiment of this application.

FIG. 3 is a schematic diagram of an optional virtual identifier processing method according to an embodiment of this application.

FIG. 4 is a schematic diagram of another optional virtual identifier processing method according to an embodiment of this application.

FIG. 5 is a schematic diagram of still another optional virtual identifier processing method according to an embodiment of this application.

FIG. 6 is a schematic diagram of still another optional virtual identifier processing method according to an embodiment of this application.

FIG. 7 is a schematic diagram of still another optional virtual identifier processing method according to an embodiment of this application.

FIG. 8 is a schematic diagram of still another optional virtual identifier processing method according to an embodiment of this application.

FIG. 9 is a schematic diagram of still another optional virtual identifier processing method according to an embodiment of this application.

FIG. 10 is a schematic diagram of still another optional virtual identifier processing method according to an embodiment of this application.

FIG. 11 is a schematic diagram of still another optional virtual identifier processing method according to an embodiment of this application.

FIG. 12 is a schematic diagram of still another optional virtual identifier processing method according to an embodiment of this application.

FIG. 13 is a schematic diagram of still another optional virtual identifier processing method according to an embodiment of this application.

FIG. 14 is a schematic diagram of still another optional virtual identifier processing method according to an embodiment of this application.

FIG. 15 is a schematic diagram of still another optional virtual identifier processing method according to an embodiment of this application.

FIG. 16 is a schematic diagram of still another optional virtual identifier processing method according to an embodiment of this application.

FIG. 17 is a schematic diagram of still another optional virtual identifier processing method according to an embodiment of this application.

FIG. 18 is a schematic diagram of still another optional virtual identifier processing method according to an embodiment of this application.

FIG. 19 is a schematic diagram of still another optional virtual identifier processing method according to an embodiment of this application.

FIG. 20 is a schematic diagram of still another optional virtual identifier processing method according to an embodiment of this application.

FIG. 21 is a schematic diagram of a structure of an optional virtual identifier processing apparatus according to an embodiment of this application.

FIG. 22 is a schematic diagram of a structure of an optional virtual identifier processing product according to an embodiment of this application.

FIG. 23 is a schematic diagram of a structure of an optional electronic device according to an embodiment of this application.

### DESCRIPTION OF EMBODIMENTS

To make a person skilled in the art better understand the solutions of this application, the following clearly and completely describes the technical solutions in embodiments of this application with reference to the accompanying drawings in embodiments of this application. Apparently, the described embodiments are merely some of embodiments of this application rather than all of embodiments of this application. All other embodiments obtained by a person of ordinary skill in the art based on embodiments of this application without creative efforts shall fall within the protection scope of this application.

In this specification, claims, and accompanying drawings of this application, the terms “first”, “second”, and the like are intended to distinguish similar objects but do not necessarily indicate a specific order or sequence. Data used in this way is interchangeable where appropriate, so that embodiments of this application described here can be implemented in an order other than those illustrated or described here. Moreover, the terms “include”, “have”, and any other variants are intended to cover the non-exclusive inclusion, for example, a process, method, system, product, or device that includes a list of operations or units is not necessarily limited to those expressly listed operations or units, but may include other operations or units not expressly listed or inherent to such a process, method, product, or device.

First, some terms used in the description of embodiments of this application are suitable for the following explanations.

Shooting game: It is a game including, but not limited to, all games using firearm for remote attacks, such as a first-person shooting game and a third-person shooting game.

First-person shooting game (FPS): It is a branch of an action game (ACT). As a name implies, the first-person shooting game is a shooting game with a subjective perspective of a player.

Third-person shooting game (TPS): It is also a type of shooting game. A difference from the first-person shooting game is that the player is visible from a game screen.

This application is described below with reference to embodiments.

According to an aspect of embodiments of this application, a virtual identifier processing method is provided. In a possible implementation, the virtual identifier processing method may be applied to a hardware environment including a server 101 and a terminal device 103 shown in FIG. 1. As shown in FIG. 1, the server 101 is connected to the terminal device 103 via a network, and may be configured to provide a service for the terminal device or an application installed on the terminal device. The application may be a video application, an instant messaging application, a browser application, an educational application, a game application, or the like. A database 105 may be disposed on the server or independently of the server, and be configured to provide a data storage service for the server 101, such as a game data storage server. The network may include, but is not limited to, a wired network and a wireless network. The wired network includes a local area network, a metropolitan area network, and a wide area network. The wireless network includes Bluetooth, Wi-Fi, and another network for wireless communication. The terminal device 103 may be a terminal configured with an application and may include, but is not limited to, at least one of the following computer devices: a mobile phone (such as an Android phone and an iOS phone), a notebook computer, a tablet computer, a palmtop computer, a mobile Internet device (MID), a desktop computer, a smart television, an intelligent voice interaction device, a smart home appliance, an on-board terminal, an aircraft, and the like. The server may be a single server, a server cluster including a plurality of servers, or a cloud server. An application 107 using the foregoing virtual identifier processing method is displayed by the terminal device 103 or another connected processing device.

Refer to FIG. 1. The foregoing virtual identifier processing method may be implemented on the terminal device 103 by using the following operations:

S1: Display, in a to-be-processed application (corresponding to the application 107) installed on the terminal device 103, a virtual scene in which a first virtual character is located and a mini-map picture, the mini-map picture being a mini-map picture corresponding to the virtual scene.

S2: Display a first location identifier on the mini-map picture of the terminal device 103 if a second virtual character in the virtual scene is defeated, the second virtual character being a virtual character in a different camp from the first virtual character, the first location identifier being configured for identifying a location of the second virtual character when being defeated in the virtual scene, and the second virtual character being allowed to be defeated by a virtual character in a different camp in the virtual scene.

S3: Display a virtual item identifier on the mini-map picture of the terminal device 103 if the second virtual character drops a virtual item set after being defeated, the virtual item identifier being configured for identifying a location of the virtual item set in the virtual scene.

The foregoing first location identifier and virtual item identifier are both virtual identifiers, and the virtual identifiers are processed by using the foregoing method.

In a possible implementation, in this embodiment, the virtual identifier processing method may alternatively be implemented by a server, for example, the server 101 shown in FIG. 1, or by a terminal device and a server jointly.

The foregoing description is only an example. This is not specifically limited in this embodiment.

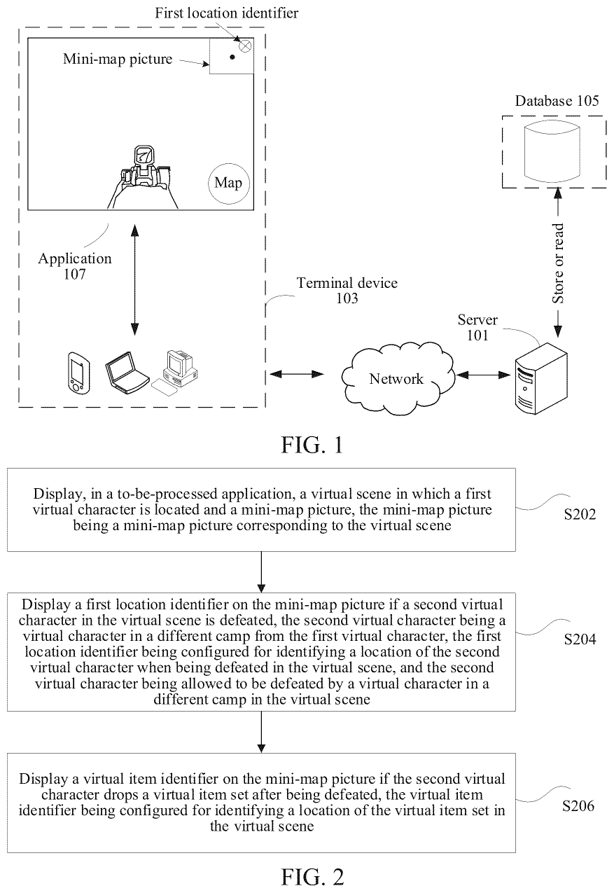

In a possible implementation, as an optional implementation, as shown in FIG. 2, the virtual identifier processing method includes:

S202: Display, in a to-be-processed application, a virtual scene in which a first virtual character is located and a mini-map picture, the mini-map picture being a mini-map picture corresponding to the virtual scene.

S204: Display a first location identifier on the mini-map picture if a second virtual character in the virtual scene is defeated, the second virtual character being a virtual character in a different camp from the first virtual character, the first location identifier being configured for identifying a location of the second virtual character when being defeated in the virtual scene, and the second virtual character being allowed to be defeated by a virtual character in a different camp in the virtual scene.

S206: Display a virtual item identifier on the mini-map picture if the second virtual character drops a virtual item set after being defeated, the virtual item identifier being configured for identifying a location of the virtual item set in the virtual scene.

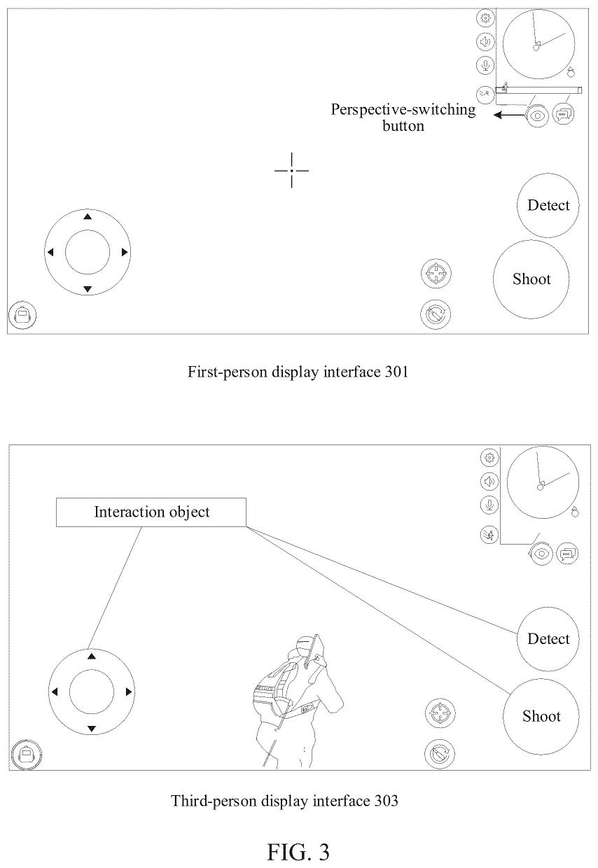

In this embodiment of this application, the virtual identifier processing method may be, but is not limited to, applied to various applications. An example in which the to-be-processed application is a game application is used. The game application may be a multilayer online battle arena (MOBA for short) game or a single-player game (SPG for short). This is not specifically limited herein. The game application may include, but is not limited to, a shooting application, a role-playing application, a real-time strategy application, and the like. The shooting application may include, but is not limited to, a first-person shooting application, a third-person shooting application, and a shooting application capable of switching between a first person and a third person. FIG. 3 is a schematic diagram of a virtual identifier processing method according to an embodiment of this application. As shown in FIG. 3, a display interface of the foregoing to-be-processed application may be divided into a first-person display interface 301 and a third-person display interface 303, and include, but is not limited to, a display interface that uses a perspective-switching button to switch between a first person and a third person.

The foregoing to-be-processed application may include, but is not limited to, at least one of the following: a two-dimensional (2D for short) game application, a three-dimensional (3D for short) game application, a virtual reality (VR for short) game application, an augmented reality (AR for short) game application, or a mixed reality (MR for short) game application. The foregoing description is only an example. This is not limited in this embodiment.

For example, in the existing related art, generally, after a specific virtual character is defeated, perception of the user's on the defeated virtual character and a virtual item dropped after the virtual character is defeated is extremely weak. Especially, after a virtual character is defeated at a distance, a location of the defeated virtual character can only be displayed through voice communication and manual marking on a map. Without marking, the user is likely to be unable to quickly know the location of the defeated virtual character to obtain a virtual item dropped by the defeated virtual character.

In this embodiment of this application, a virtual scene corresponding to the first virtual character may include, but is not limited to, a game picture displayed on a terminal of a game application to which a player controlling the first virtual character logs in. The mini-map picture may include, but is not limited to, a thumbnail of the virtual scene. Using the game application as an example, the mini-map picture may include, but is not limited to, a game thumbnail displayed in the game picture of the game application. The mini-map picture may include, but is not limited to, a panoramic map configured as a current game, and may further include, but is not limited to, a partial map using the first virtual character as a center.

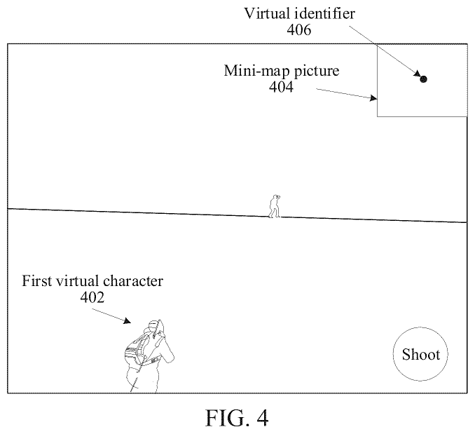

An example in which the mini-map picture is a part of a map using the first virtual character as a center is used. FIG. 4 is a schematic diagram of another virtual identifier processing method according to an embodiment of this application. As shown in FIG. 4, a first virtual character 402, a mini-map picture 404, and a virtual identifier 406 are displayed on a game picture of a game application. The first virtual character 402 is located in a first location in a virtual scene. A thumbnail area corresponding to an area using the first virtual character as a center and using a preset distance as a radius in the virtual scene is displayed on the mini-map picture 404. The virtual identifier 406 may be a center of the mini-map picture 404 and configured for indicating a location of the first virtual character 402 in the virtual scene. The thumbnail may further include, but is not limited to, a virtual identifier displaying a location of another virtual character in the same camp as the first virtual character.

The foregoing description is only an example. This is not specifically limited in this embodiment of this application.

When the first virtual character attacks another virtual character, real-time battle information such as an attack direction of the first virtual character attacking the another virtual character may be displayed on the game picture.

In this embodiment of this application, the second virtual character may be a virtual character in a different camp from the first virtual character. To be specific, the first virtual character is allowed to attack the second virtual character. The second virtual character may be allowed or not be allowed to attack on the first virtual character, which is not limited thereto. The second virtual character may include, but is not limited to, a virtual character controlled by another user, and may further include, but is not limited to, a non-player character (NPC) controlled by artificial intelligence (AI).

In a possible implementation, in this embodiment of this application, the second virtual character being defeated in the virtual scene may be understood that a virtual hit point of the second virtual character satisfies a preset condition, for example, the virtual hit point of the second virtual character drops to 0, and the virtual hit point of the second virtual character drops to 20% of an initial value or a maximum value, and may further be understood that the second virtual character is in an eliminated state. In this case, the second virtual character cannot continue to participate in a current task, game, or the like, for example, being knocked down or under control.

In a possible implementation, in this embodiment of this application, the first location identifier is an identifier that is displayed on the mini-map picture and that is configured for identifying the location of the defeated second virtual character.

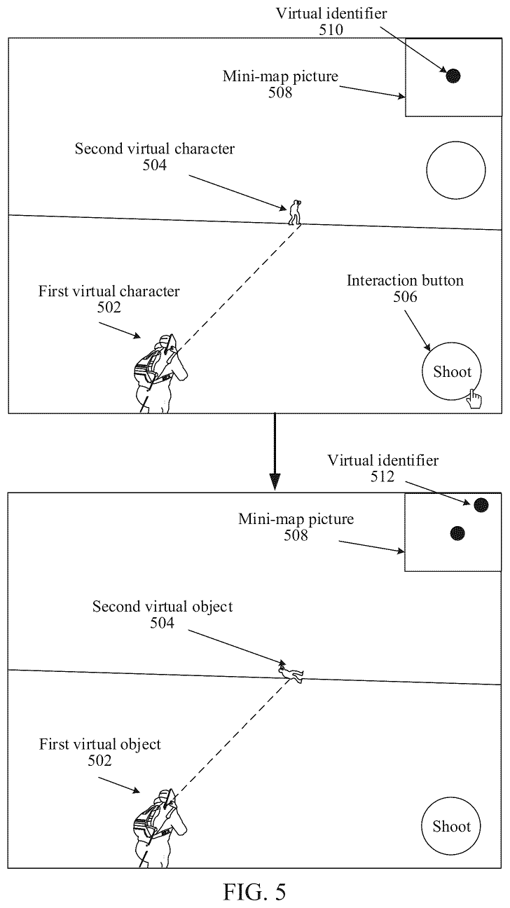

For example, FIG. 5 is a schematic diagram of still another virtual identifier processing method according to an embodiment of this application. As shown in FIG. 5, a first virtual character 502, a second virtual character 504, an interaction button 506, a mini-map picture 508, a virtual identifier 510, and a virtual identifier 512 are displayed on a game picture of a game application. The first virtual character 502 is located in a first location in a virtual scene. A thumbnail area corresponding to an area using the first virtual character as a center and using a preset distance as a radius in the virtual scene is displayed on the mini-map picture 508. The virtual identifier 506 is the center of the mini-map picture 508 and is configured for representing a location of the first virtual character 502 in the virtual scene. When a user controls the first virtual character 502 to perform an interaction operation on the interaction button 506, the first virtual character 502 controls a virtual item to shoot the second virtual character 504. When the second virtual character 504 is defeated, the virtual identifier 512 is displayed on the mini-map picture 508. The virtual identifier 512 may be a first location identifier and configured for indicating a location of the second virtual character 504 in the virtual scene.

The foregoing description is only an example. This is not specifically limited in this embodiment of this application.

In this embodiment of this application, the displaying the first location identifier on the mini-map picture may include, but is not limited to, displaying a preset location identifier, for example, a circle, a triangle, or a rectangle to mark the location of the second virtual character on the mini-map picture, and may further include, but is not limited to, displaying an identifier associated with the second virtual character, for example, a camp identifier of the second virtual character or a team identifier of the second virtual character.

In this embodiment of this application, the different camp may include, but is not limited to, a grouping preset before a current game is entered and a grouping performed in a manner of a preset grouping operation during playing of the current game. The grouping here is configured for indicating camps to which a plurality of virtual characters participating in the same game task belong, and the virtual characters in different camps may attack each other. Specifically, the virtual characters in different camps may be configured to oppose each other.

In this embodiment of this application, the first location identifier being configured for identifying a location of the second virtual character when being defeated in the virtual scene may be understood that during movement of the second virtual character, the first location identifier is configured for identifying the location of the second virtual character when being defeated, or the first location identifier is configured for identifying an estimated location of the second virtual character after a preset duration after a moment of being defeat. For example, when the second virtual character is in a virtual vehicle, if the second virtual character is defeated at a first moment, a trajectory that the second virtual character moves after the preset duration is determined based on movement speed of the virtual vehicle and a location that the second virtual character is allowed to reach after the preset duration is estimated.

The first location identifier of the second virtual character after being defeated being displayed on the mini-map picture may be understood that the second virtual character may still move after being defeated. In this case, a distance that the virtual vehicle is allowed to move when being not controlled by the second virtual character is determined based on the movement speed of the virtual vehicle used by the second virtual character, and a moved location of the defeated second virtual character is continuously displayed. It may alternatively be understood that during the movement of the second virtual character, when staying duration of the second virtual character exceeds a preset value, the moved location of the second virtual character is displayed as the first location identifier. This is not limited thereto.

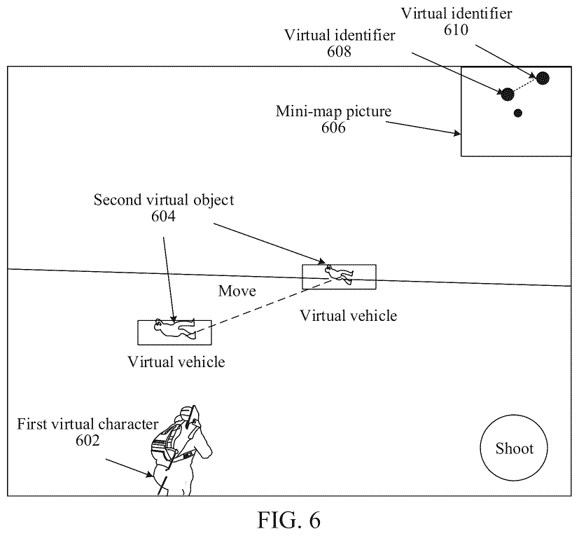

For example, FIG. 6 is a schematic diagram of still another virtual identifier processing method according to an embodiment of this application. As shown in FIG. 6, a first virtual character 602, a second virtual character 604, a mini-map picture 606, a virtual identifier 608, and a virtual identifier 610 are included. A player controls the first virtual character 602. When the player controls the first virtual character 602 to defeat the second virtual character 604, because the second virtual character is using a virtual vehicle to move, in this case, a corresponding moving trajectory of the second virtual character 604 is continuously displayed based on movement speed of the virtual vehicle, or an estimated stopping location of the second virtual character 604 is displayed based on the movement speed of the virtual vehicle. To be specific, the virtual identifier 608 moves to the upper right of the mini-map picture to the virtual identifier 610, and the virtual identifier 610 is used as the first location identifier.

The foregoing description is only an example. This is not specifically limited in this embodiment of this application.

In a possible implementation, in this embodiment of this application, after the second virtual character is defeated, a virtual item set is dropped at the location where the second virtual character is defeated. The virtual item set may include, but is not limited to, a virtual item set including a virtual item that is allowed to be dropped by the second virtual character, and may further include, but is not limited to, a virtual item set including a reward virtual item configured by a system for defeating the second virtual character.

The virtual item in the virtual item set may include, but is not limited to, a virtual skill, a virtual resource, a virtual gold coin, virtual ammunition, a virtual equipment, a virtual point, and the like.

In a possible implementation, in this embodiment of this application, the virtual item identifier may be understood as an identifier that is only configured for indicating a location of the virtual item set in the virtual scene, and may alternatively be understood as a virtual item identifier including prompt information. The prompt information may indicate that the virtual item set includes a target virtual item, indicate whether the virtual item set includes a virtual item of a preset type, indicate a quantity of virtual items of the preset type in the virtual item set, indicate remaining duration that the virtual item of the preset type in the virtual item set is allowed to be obtained, and the like, but is not limited thereto, and may include, but is not limited to, one or more combinations of the above.

In a possible implementation, in this embodiment of this application, the virtual item identifier may be displayed synchronously with the first location identifier. In this case, the virtual item identifier may be displayed within a preset range of the first location identifier, for example, directly above and directly below the first location identifier, to indicate that the first location identifier and the virtual item identifier are associated with the same second virtual character.

In a possible implementation, in this embodiment of this application, the virtual item identifier may be displayed asynchronously with the first location identifier. In this case, in a case that the virtual item identifier may satisfy a preset condition in a display process of the first location identifier, display of the first location identifier is canceled, and then the virtual item identifier is displayed to avoid displaying excessive virtual identifiers in the mini-map picture, causing the user to be unable to efficiently determine whether the defeated second virtual character drops a virtual item.

The second virtual character when being defeated may alternatively be configured not to drop any virtual item. In this case, a virtual identifier configured for indicating that the second virtual character does not drop any virtual item may be displayed to inform the user that the second virtual character does not drop any virtual item, or the first location identifier is adjusted in one or more combinations of dimensions such as a color, a size, and a shape to inform the user that the second virtual character does not drop any virtual item.

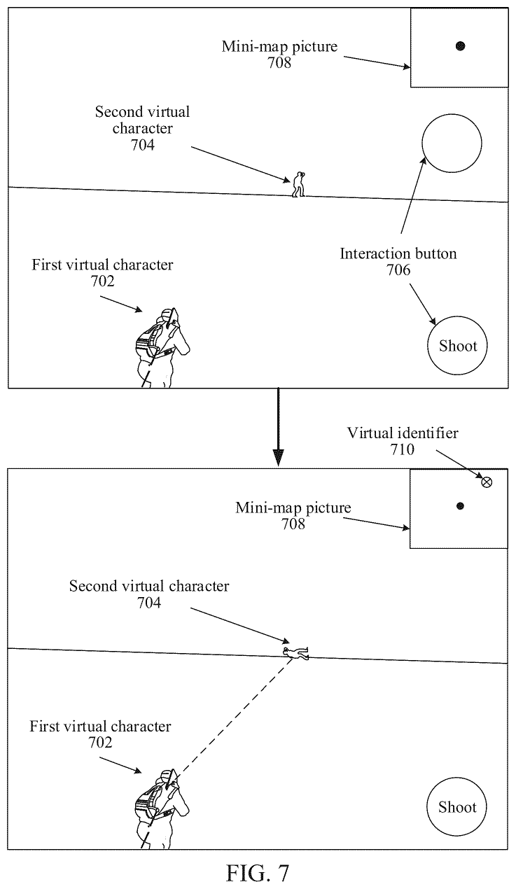

For example, FIG. 7 is a schematic diagram of still another virtual identifier processing method according to an embodiment of this application. As shown in FIG. 7, a first virtual character 702, a second virtual character 704, an interaction button 706, a mini-map picture 708, and a virtual identifier 710 are included. When the second virtual character is defeated by the first virtual character or is defeated by a third virtual character in the same camp as the first virtual character, the virtual identifier 710 is displayed on the mini-map picture to indicate that there is the defeated second virtual character at the location.

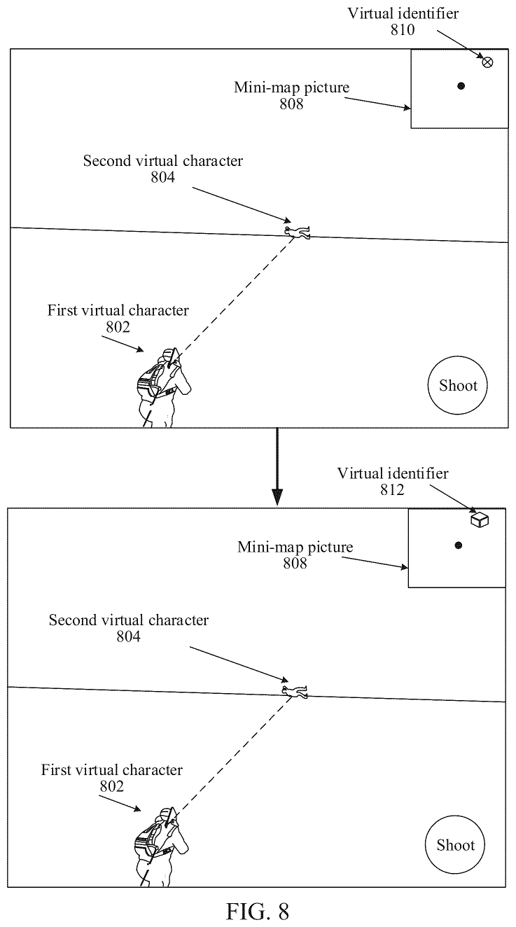

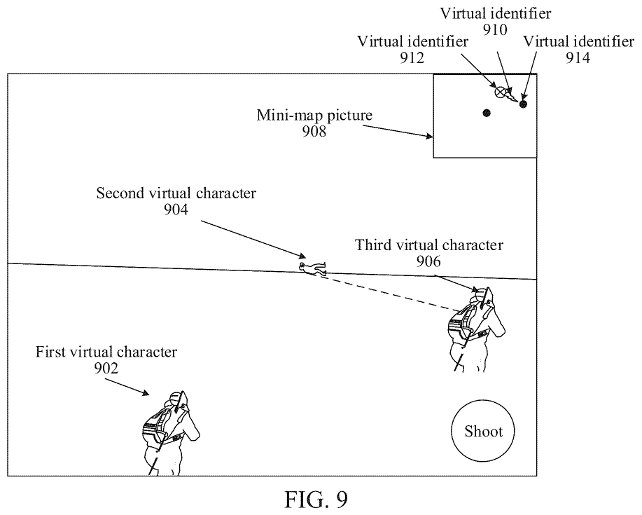

For example, FIG. 8 is a schematic diagram of still another virtual identifier processing method according to an embodiment of this application. As shown in FIG. 8, a first virtual character 802, a second virtual character 804, an interaction button 806, a mini-map picture 808, a virtual identifier 810, and a virtual identifier 812 are included. When the second virtual character is defeated by the first virtual character or is defeated by a third virtual character in the same camp as the first virtual character, the virtual identifier 810 is displayed on the mini-map picture to indicate that there is the defeated second virtual character at the location. When display duration of the virtual identifier 810 exceeds first preset duration, display of the virtual identifier 810 is canceled, and the virtual identifier 812 is displayed to indicate that there is a virtual item set dropped by the defeated second virtual character at the location.

The foregoing description is only an example. This is not specifically limited in this embodiment of this application.

In embodiments of this application, a virtual scene in which a first virtual character is located and a mini-map picture are displayed in a to-be-processed application. The mini-map picture is a mini-map picture corresponding to the virtual scene. A first location identifier is displayed on the mini-map picture if a second virtual character in the virtual scene is defeated. The second virtual character is a virtual character in a different camp from the first virtual character. The second virtual character is allowed to be defeated by a virtual character in a different camp in the virtual scene. The first location identifier is configured for identifying a location of the second virtual character when being defeated in the virtual scene, thereby facilitating quick determining of the location of the defeated virtual character based on the first location identifier. A virtual item identifier is displayed on the mini-map picture if the second virtual character drops a virtual item set after being defeated. The virtual item identifier is configured for identifying a location of the virtual item set in the virtual scene, thereby facilitating quick obtaining of the virtual item dropped by the defeated virtual character based on the virtual item identifier. The mini-map picture displays the location of the defeated virtual character and the virtual item dropped by the defeated virtual character, to facilitate a user quickly obtaining of the location of the defeated virtual character and information of the dropped virtual item set without need for the user to manually mark the dropped virtual item set, so that the virtual item set is quickly and effectively positioned to prevent the user from not being able to find loot after an enemy is defeated and needing active marking and the like. In this way, positioning time and analysis time of the user can be saved, and the user can view a virtual identifier efficiently, so that a technical effect of simplifying a virtual identifier processing method and improving virtual identifier processing efficiency is achieved, thereby further resolving a technical problem that efficiency of processing a virtual identifier is low due to a complex virtual identifier processing method in related art.

As an optional solution, the displaying a first location identifier on the mini-map picture if a second virtual character in the virtual scene is defeated includes:

displaying a second location identifier on the mini-map picture, the second location identifier being configured for identifying a location of a third virtual character in the virtual scene, and the third virtual character being a virtual character in a same camp as the first virtual character; and

displaying the first location identifier and a direction identifier on the mini-map picture if the second virtual character is defeated by the third virtual character, the direction identifier being configured for identifying an attack direction, and the attack direction pointing from a location indicated by the second location identifier to a location indicated by the first location identifier.

In a possible implementation, in this embodiment of this application, the second location identifier is a location identifier displayed by the third virtual character on the mini-map picture of the first virtual character. To be specific, the mini-map picture uses the first virtual character as a center, and a location of the third virtual character in the virtual scene is displayed on the mini-map picture in a manner of a number or another virtual identifier.

In a possible implementation, in this embodiment of this application, the direction identifier may be represented as an attack direction of the third virtual character. Because the second virtual character is defeated by the third virtual character, the direction identifier represents the attack direction of the third virtual character when the second virtual character is defeated. To be specific, the attack direction points from the location indicated by the second location identifier to the location indicated by the first location identifier.

For example, FIG. 9 is a schematic diagram of still another virtual identifier processing method according to an embodiment of this application. As shown in FIG. 9, a first virtual character 902, a second virtual character 904, a third virtual character 906, a mini-map picture 908, a virtual identifier 910, a virtual identifier 912, and a virtual identifier 914 are included. The virtual identifier 910 represents the direction identifier to indicate an attack direction of the third virtual character when the second virtual character is defeated. The virtual identifier 912 represents the first location identifier to indicate a location of the second virtual character when the second virtual character is defeated. The virtual identifier 914 represents the second location identifier to indicate a location of the third virtual character when the second virtual character is defeated.

The foregoing description is only an example. This is not specifically limited in this embodiment of this application.

According to this embodiment, a teammate of the user can learn information of a virtual item set dropped by a defeated virtual character without frequent marking operations. After a box is displayed on the mini-map picture, the teammate can also quickly learn a location of the box without frequent marking operations.

As an optional solution, the displaying a virtual item identifier on the mini-map picture if the second virtual character drops a virtual item set after being defeated includes:

displaying the virtual item identifier within a preset range of the first location identifier if the second virtual character drops the virtual item set after being defeated, and the first location identifier is displayed on the mini-map picture; or

canceling display of the first location identifier and displaying the virtual item identifier if a display process of the first location identifier satisfies a preset condition, and the second virtual character drops the virtual item set after being defeated.

In a possible implementation, in this embodiment of this application, the preset range of the first location identifier may be configured such that the first location identifier and the virtual item identifier do not overlap in the display process and are displayed adjacently, but is not limited thereto, to associate the first location identifier and the virtual item identifier as a first location identifier and a virtual item identifier displayed when the same second virtual character is defeated. For example, the virtual item identifier is displayed synchronously within a preset distance in a directly above direction, a directly below direction, and the like of the first location identifier.

In a possible implementation, in this embodiment of this application, the display process of the first location identifier satisfying the preset condition may include that display duration of the first location identifier reaches first preset duration, or that the second virtual character corresponding to the first location identifier has re-participated in a current game, which is not limited thereto.

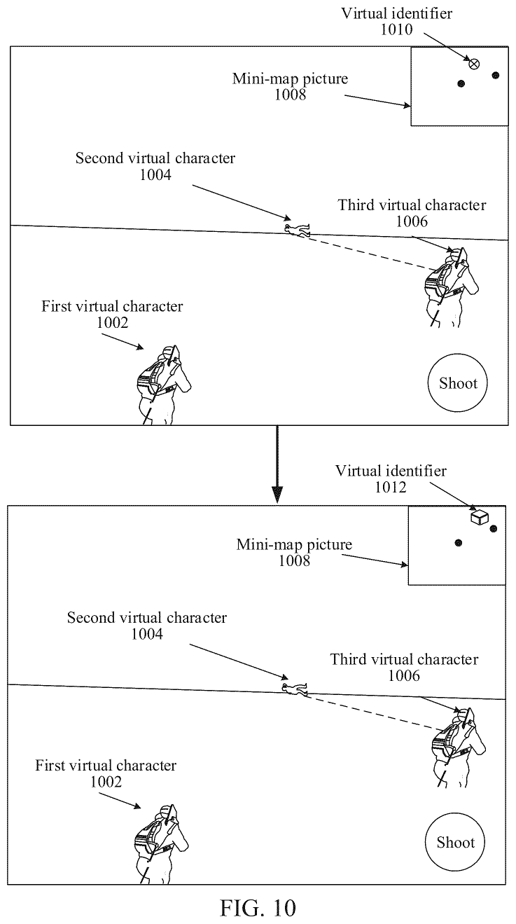

For example, FIG. 10 is a schematic diagram of still another virtual identifier processing method according to an embodiment of this application. As shown in FIG. 10, a first virtual character 1002, a second virtual character 1004, a third virtual character 1006, a mini-map picture 1008, a virtual identifier 1010, and a virtual identifier 1012 are included. The virtual identifier 1010 represents the foregoing first location identifier to indicate a location of the second virtual character when the second virtual character is defeated by the third virtual character. After a display process of the virtual identifier 1010 satisfies a preset condition, the virtual identifier 1010 is switched to be displayed as the virtual identifier 1012 (that is, a virtual item identifier) to indicate a location of a virtual item set dropped by the third virtual character when the second virtual character is defeated by the third virtual character.

The foregoing description is only an example. This is not specifically limited in this embodiment of this application.

According to this embodiment, a user can see location information that another virtual character is defeated by a teammate on the mini-map picture, and simultaneously, the virtual item set dropped after a virtual character is defeated is displayed, so that the user can efficiently see the location of the virtual item set and a virtual item with a highest level included in the virtual item set, saving time for the user to search for the virtual item set and time for the teammate to mark the virtual item set.

As an optional solution, the canceling display of the first location identifier and displaying the virtual item identifier if a display process of the first location identifier satisfies a preset condition, and the second virtual character drops the virtual item set after being defeated includes:

canceling the display of the first location identifier on the mini-map picture if display duration of the first location identifier on the mini-map picture reaches first preset duration; and

displaying the virtual item identifier on the mini-map picture if the second virtual character drops the virtual item set after being defeated, a display position of the virtual item identifier displayed on the mini-map picture being the same as a display position of the first location identifier before the display is canceled.

In a possible implementation, in this embodiment of this application, the first preset duration is preset duration and may be determined based on a character type of the second virtual character. For example, when the second virtual character is a non-player character (NPC), long first preset duration is set. When the second virtual character is a virtual character controlled by a player, short first preset duration is set to configure different first duration to display the foregoing first location identifier in a player versus player (PVP) scene and a player versus environment (PVE) scene.

In a possible implementation, in this embodiment of this application, the display position of the virtual item identifier displayed on the mini-map picture being the same as the display position of the first location identifier before the display is canceled may be understood that the virtual item identifier is displayed at a location previously displayed the first location identifier to indicate that the first location identifier and the virtual item identifier are associated with the same second virtual character. In other words, the virtual item set dropped by the defeated virtual character corresponding to the first location identifier is displayed as the virtual item identifier.

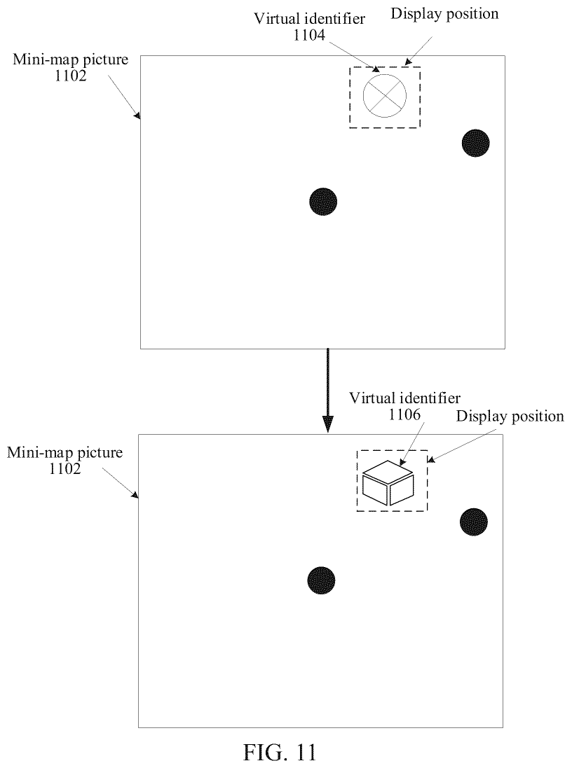

For example, FIG. 11 is a schematic diagram of still another virtual identifier processing method according to an embodiment of this application. As shown in FIG. 11, a mini-map picture 1102, a virtual identifier 1104, and a virtual identifier 1106 are included. The virtual identifier 1104 represents the first location identifier. When display duration of the virtual identifier 1104 on the mini-map picture 1102 reaches first preset duration, display of the virtual identifier 1104 is canceled, and the virtual identifier 1106 is displayed at the display position as a virtual item identifier to indicate that the first location identifier and the virtual item identifier are associated with the same defeated second virtual character.

According to this embodiment, after the display of the first location identifier is cancel, the virtual item identifier is displayed at the same position, to indicate that the defeated second virtual character indicated by the first location identifier and the second virtual character whose virtual item set is dropped indicated by the virtual item identifier are the same second virtual character, avoiding a technical problem that when a plurality of second virtual characters are defeated in short time, the user cannot quickly find a corresponding first location identifier and virtual item identifier due to excessively virtual identifiers displayed in the mini-map picture.

As an optional solution, after a virtual item identifier is displayed on the mini-map picture if the second virtual character drops a virtual item set after being defeated, the method further includes:

canceling display of the virtual item identifier on the mini-map picture if display duration of the virtual item identifier on the mini-map picture reaches second preset duration.

In a possible implementation, in this application embodiment, the second preset duration may be the same as or different from the first preset duration. When the display duration of the virtual item identifier displayed on the mini-map picture reaches the second preset duration, it may be understood that the user has viewed the virtual item identifier. In this case, the display of the virtual item identifier is canceled, so that when a next second virtual character is defeated, a first location identifier and a virtual item identifier of the next second virtual character when being defeated are displayed again more clearly.

As an optional solution, the displaying a virtual item identifier on the mini-map picture if the second virtual character drops a virtual item set after being defeated includes:

displaying the virtual item identifier having target prompt information if the second virtual character drops the virtual item set after being defeated, the target prompt information being configured for indicating that the virtual item set includes a target virtual item, and the target virtual item being a virtual item satisfying a preset condition in the virtual item set.

In a possible implementation, in this embodiment of this application, the target prompt information is configured for indicating that the virtual item set includes the target virtual item, and the target virtual item is a virtual item satisfying the preset condition. For example, the target virtual item includes a key task item in a current virtual scene. When the second virtual character drops the key task item, the virtual item identifier not only marks the location of the virtual item set dropped after the second virtual character is defeated, and indicates that the virtual item set includes the key task item, so that the user quickly learns the virtual item included in the virtual item set dropped after the second virtual character is defeated.

As an optional solution, displaying the virtual item identifier having target prompt information if the second virtual character drops the virtual item set after being defeated includes:

obtaining preset item levels of virtual items in the virtual item set if the second virtual character drops the virtual item set after being defeated; and

determining a virtual item with a highest preset item level in the virtual item set as the target virtual item, and displaying the virtual item identifier having the target prompt information, the target prompt information being configured for indicating that the virtual item set includes the target virtual item with the highest preset item level.

In a possible implementation, in this embodiment of this application, the preset item level is a pre-configured item level of each virtual item in the virtual item set dropped after the second virtual character is defeated. For example, a virtual helmet may be pre-configured as a level-one virtual helmet, a level-two virtual helmet, and a level-three virtual helmet. A virtual bulletproof vest may be pre-configured as a level-one virtual bulletproof vest, a level-two virtual bulletproof vest, and a level-three virtual bulletproof vest. When the virtual item set dropped by the second virtual character includes the level-two virtual helmet and the level-three virtual bulletproof vest, a preset item level, which is level 2, corresponding to the level-two virtual helmet is obtained, and a preset item level, which is level 3, corresponding to the level-three virtual bulletproof vest is obtained. The virtual item with the highest preset item level being used as the target virtual item in the virtual item set may be understood that a virtual item with the preset item level of 3 is used as the target virtual item to display the virtual item identifier. The target prompt information may indicate that the virtual item set includes the target virtual item with the highest preset item level through one or more combinations, but is not limited thereto, of a number, a color, a symbol, and the like.

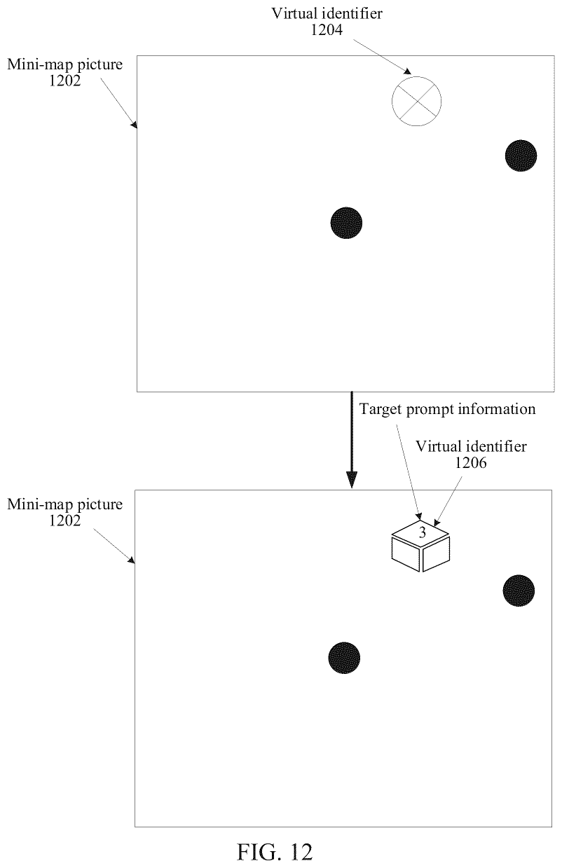

For example, FIG. 12 is a schematic diagram of still another virtual identifier processing method according to an embodiment of this application. As shown in FIG. 12, a mini-map picture 1202, a virtual identifier 1204, and a virtual identifier 1206 are included. The virtual identifier 1204 represents a first location identifier corresponding to a second virtual character after being defeated. When the virtual identifier 1204 is switched to be displayed as the virtual identifier 1206 on the mini-map picture 1202 as a virtual item identifier, target prompt information “3” is displayed on the virtual identifier 1206 to indicate that a virtual item set corresponding to the virtual item identifier includes a target virtual item with a highest preset item level of 3.

As an optional solution, the determining a virtual item with a highest preset item level in the virtual item set as the target virtual item, and displaying the virtual item identifier having the target prompt information includes:

obtaining item color information of the target virtual item, the item color information being associated with the preset item level of the target virtual item; and

displaying the virtual item identifier having the target prompt information based on the item color information, color information of the virtual item identifier being associated with the item color information of the target virtual item.

In a possible implementation, in this embodiment of this application, the item color information may include, but is not limited to, color information indicating the preset item level of the target virtual item, for example, may include, but is not limited to, orange, red, purple, blue, green, white, and another color indicating different preset item levels. For example, different virtual items may be configured with the same or different item levels (corresponding to the foregoing preset item levels). A virtual item with a highest item level is configured as an orange virtual item, and a virtual item with a lowest item level is configured as a white virtual item. When the virtual item identifier with the target prompt information is displayed, the item color information indicating the preset item level may be used as the target prompt information. For example, a color of the virtual item identifier may be changed to a color indicated by the item color information, so that the user may quickly determine the target virtual item with the highest preset item level in the virtual item set based on the color of the virtual item identifier.

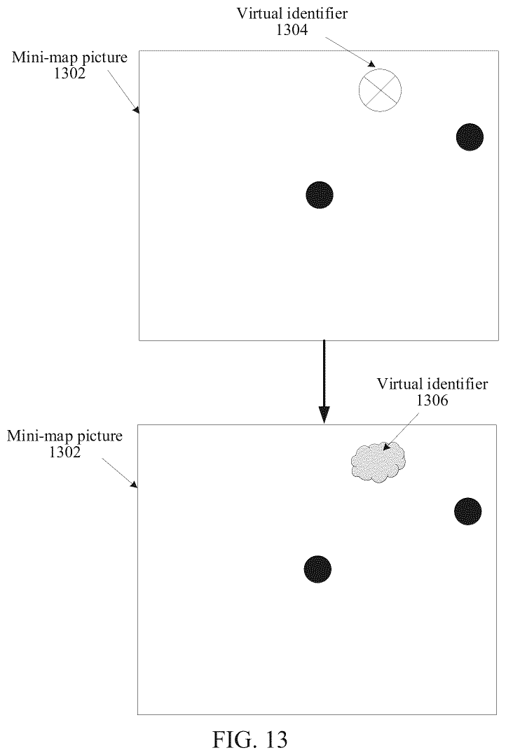

For example, FIG. 13 is a schematic diagram of still another virtual identifier processing method according to an embodiment of this application. As shown in FIG. 13, a mini-map picture 1302, a virtual identifier 1304, and a virtual identifier 1306 are included. The virtual identifier 1304 represents a first location identifier corresponding to a second virtual character after being defeated. When the virtual identifier 1304 is switched to be displayed as the virtual identifier 1306 on the mini-map picture 1302 as a virtual item identifier, a color of the virtual identifier 1306 is displayed as a color indicated by item color information corresponding to a target virtual item. When the item color information of the target virtual item is gray, the gray virtual identifier 1306 is displayed. The gray virtual identifier 1306 represents that a virtual item set corresponding to the virtual item identifier includes a target virtual item with a highest preset item level of a gray level.

A user can see defeat information of a teammate on the mini-map picture, and simultaneously, a dropped defeat virtual item level is displayed, so that the user can efficiently see the location of the virtual item set and a virtual item with a highest level included in the virtual item set, saving time for the user to search for the virtual item set and time for the teammate to mark the virtual item set.

As an optional solution, the displaying a virtual item identifier on the mini-map picture if the second virtual character drops a virtual item set after being defeated includes at least one of the following:

displaying the virtual item identifier having first prompt information if the second virtual character drops the virtual item set after being defeated, the first prompt information being configured for indicating whether the virtual item set includes a virtual item of a preset type;

displaying the virtual item identifier having second prompt information if the second virtual character drops the virtual item set after being defeated, the second prompt information being configured for indicating a quantity of virtual items of the preset type in the virtual item set; or

displaying the virtual item identifier having third prompt information if the second virtual character drops the virtual item set after being defeated, the third prompt information being configured for indicating remaining duration that the virtual item of the preset type in the virtual item set is allowed to be obtained.

In a possible implementation, in this embodiment of this application, the foregoing first prompt information, second prompt information, and third prompt information may be displayed inside the virtual item identifier or displayed around the virtual item identifier.

The first prompt information is configured for indicating whether the virtual item set includes a virtual item of a preset type. For example, a green identifier is used as the first prompt information to indicate that the virtual item set includes a virtual item of a preset type. A red identifier is used as the first prompt information to indicate that the virtual item set includes a virtual item of a preset type.

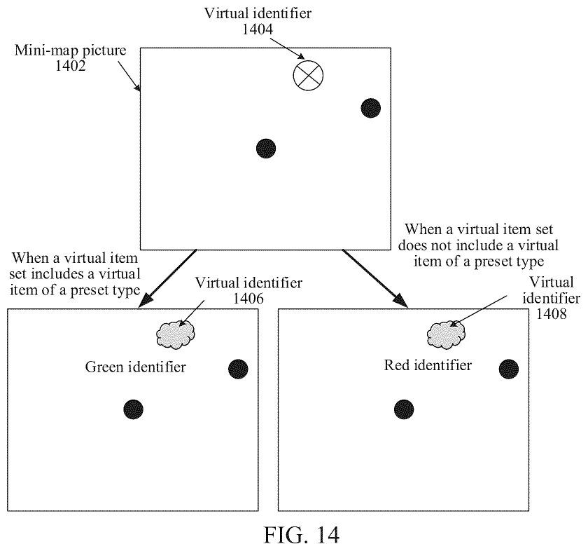

For example, FIG. 14 is a schematic diagram of still another virtual identifier processing method according to an embodiment of this application. As shown in FIG. 14, a mini-map picture 1402, a virtual identifier 1404, a virtual identifier 1406, and a virtual identifier 1408 are included. The virtual identifier 1404 represents a first location identifier corresponding to a second virtual character after being defeated. When the virtual identifier 1404 is switched to be displayed as the virtual identifier 1406 on the mini-map picture 1402 as a virtual item identifier, the green virtual identifier 1406 indicates that a virtual item set includes a virtual item of a preset type. When the virtual identifier 1404 is switched to be displayed as the virtual identifier 1408 on the mini-map picture 1402 as a virtual item identifier, the red virtual identifier 1408 is used as the first prompt information to indicate that the virtual item set includes a virtual item of a preset type.

The second prompt information is configured for indicating a quantity of virtual items of the preset type in the virtual item set. For example, number prompt information is displayed to indicate the quantity of virtual items of the preset type in the virtual item set.

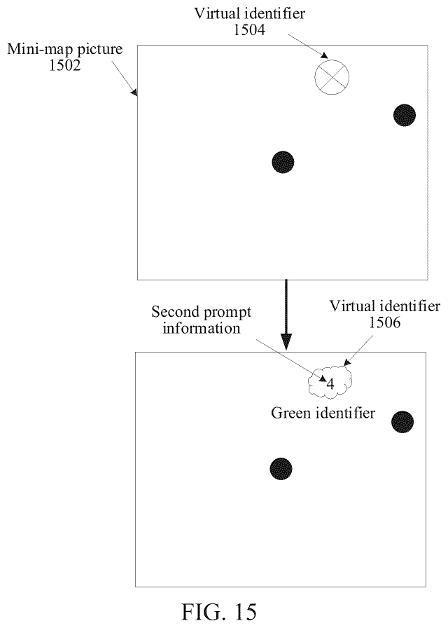

For example, FIG. 15 is a schematic diagram of still another virtual identifier processing method according to an embodiment of this application. As shown in FIG. 15, a mini-map picture 1502, a virtual identifier 1504, and a virtual identifier 1506 are included. The virtual identifier 1504 represents a first location identifier corresponding to a second virtual character after being defeated. When the virtual identifier 1504 is switched to be displayed as the virtual identifier 1506 on the mini-map picture 1502 as a virtual item identifier, number prompt information is added to the virtual identifier 1506 as a virtual item identifier having second prompt information to indicate a quantity of virtual items of the preset type in the virtual item set corresponding to the virtual item identifier 1506.

The third prompt information is configured for indicating remaining duration that the virtual item of the preset type in the virtual item set is allowed to be obtained. The remaining duration that the virtual item is allowed to be obtained may be understood as countdown information. A value of the countdown information indicates how much duration is remained to obtain the virtual item. When the countdown information reaches 0, it is no longer allowed to obtain the virtual item of the preset type.

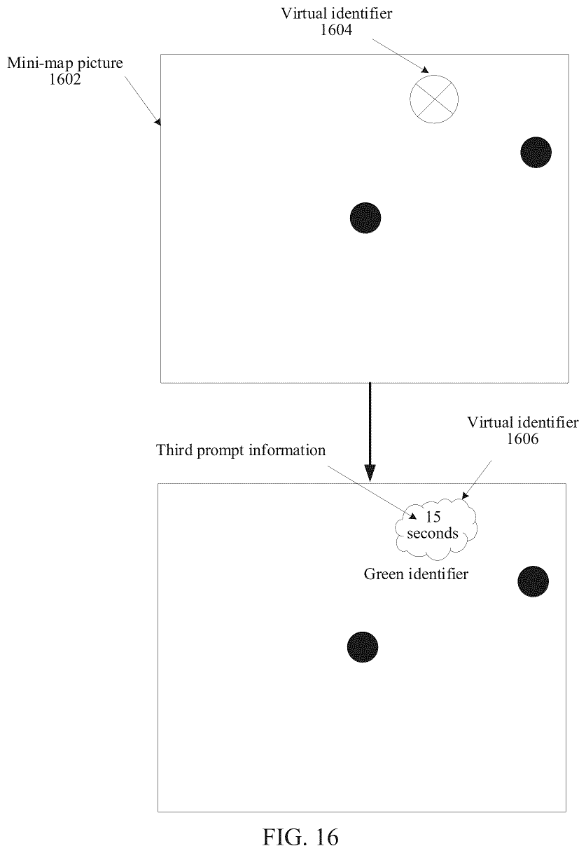

For example, FIG. 16 is a schematic diagram of still another virtual identifier processing method according to an embodiment of this application. As shown in FIG. 16, a mini-map picture 1602, a virtual identifier 1604, and a virtual identifier 1606 are included. The virtual identifier 1604 represents a first location identifier corresponding to a second virtual character after being defeated. When the virtual identifier 1604 is switched to be displayed as the virtual identifier 1606 on the mini-map picture 1602 as a virtual item identifier, countdown prompt information is added to the virtual identifier 1606 as a virtual item identifier having third prompt information to indicate remaining duration that the virtual item of the preset type in the virtual item set is allowed to be obtained corresponding to the virtual item identifier 1606.

As an optional solution, the method provided in this embodiment of this application further includes:

displaying the first location identifier on a target boundary point of the mini-map picture if a location of the second virtual character when being defeated is located outside a target area, the target area being an area in the virtual scene represented by the mini-map picture, and the target boundary point being a boundary point determined based on the location of the second virtual character when being defeated relative to a direction of the target area;

displaying, in response to a first trigger operation on a target map, the target map, the target map being a map associated with the virtual scene, and an area in the virtual scene represented by the target map including the target area and an area in which the location of the second virtual character when being defeated is located;

displaying a map location identifier on the target map, the map location identifier being configured for identifying, on the target map, the location of the second virtual character when being defeated in the virtual scene; and

displaying a map item identifier on the target map if the second virtual character drops the virtual item set after being defeated, the map item identifier being configured for identifying, on the target map, a location of the virtual item set in the virtual scene.

In a possible implementation, in this embodiment of this application, the target area is an area displayed on the mini-map picture corresponding to the virtual scene. The location of the second virtual character when being defeated being located outside the target area may be understood that the location of the second virtual character when being defeated is not located within the target area. In other words, an area corresponding to the location of the second virtual character when being defeated is not displayed on the mini-map picture.

For example, the virtual scene is divided into area A, area B, area C, and area D. When the first virtual character is located in area B, content displayed on the mini-map picture includes area B. When the second virtual character is defeated in area A, because the mini-map picture does not include area A, the first location identifier is displayed on a boundary point of area B closest to area A to indicate the location of the second virtual character when being defeated.

In a possible implementation, in this embodiment of this application, the target boundary point being a boundary point determined based on the location of the second virtual character when being defeated relative to a direction of the target area may be understood that a ray is emitted from the location of the second virtual character when being defeated to a center point of the target area. An intersection point of the ray and the target area is the target boundary point.

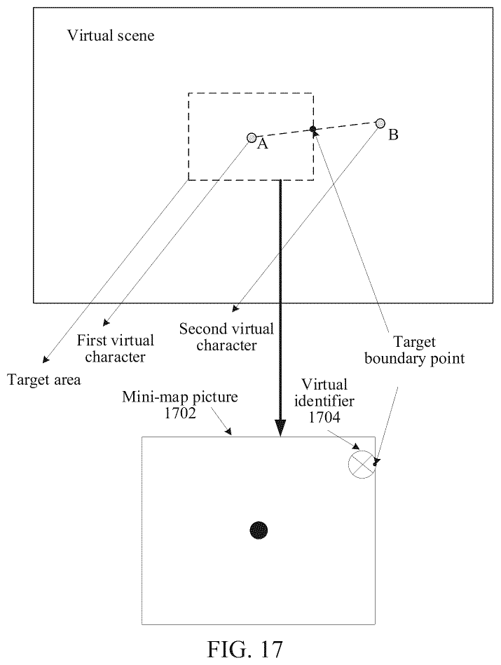

For example, FIG. 17 is a schematic diagram of still another virtual identifier processing method according to an embodiment of this application. As shown in FIG. 17, a first virtual character is located at point A inside a target area in a virtual scene. Therefore, content displayed on a mini-map picture 1702 represents the target area. A location of a second virtual character when being defeated is located at point B outside the target area. A ray is emitted from point B to be connected to point A. An intersection point of ray BA and the target area is determined as the foregoing target boundary point, and a virtual identifier 1704 is displayed on a target boundary point corresponding to the mini-map picture 1702 to represent the foregoing first location identifier.

In a possible implementation, in this embodiment of this application, the target map may include, but is not limited to, a complete map representing the virtual scene. The first trigger operation is an operation for triggering display of the target map, and may be implemented by, but not limited to, performing an interaction operation on an interaction object for displaying the target map. The first trigger operation may include, but is not limited to, one or more combinations of clicking/tapping, touching and holding, double clicking/tapping, a gesture, a voice, and the like. The area in the virtual scene represented by the target map includes at least the target area and the area in which the second virtual character when being defeated is located.

In a possible implementation, in this embodiment of this application, the target map may be displayed through the first trigger operation, and a map location identifier is displayed on the target map. The map location identifier is configured for identifying, on the target map, the location of the second virtual character when being defeated in the virtual scene.

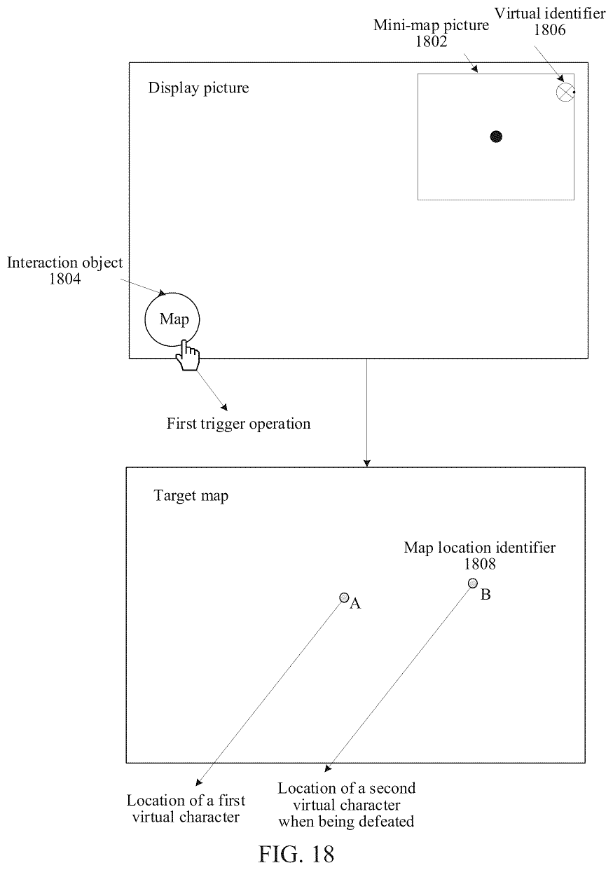

For example, FIG. 18 is a schematic diagram of still another virtual identifier processing method according to an embodiment of this application. As shown in FIG. 18, a game picture of a first virtual character includes a mini-map picture 1802 and an interaction object 1804. A virtual identifier 1806 is displayed on a boundary of the mini-map picture 1802. When the virtual identifier 1806 is displayed, it may be understood that there is a defeated second virtual character outside an area corresponding to the mini-map picture 1802. In this case, a first trigger operation is performed on the interaction object 1804 to display a complete target map, and point A and point B are displayed on the target map. A location of the first virtual character is located at point A on the target map, and a location of the second virtual character when being defeated is located at point B on the target map. A map location identifier 1808 is displayed on the target map, so that a user controlling the first virtual character may intuitively learn the location of the second virtual character when being defeated by viewing the target map.

In a possible implementation, in this embodiment of this application, the map item identifier may be configured to be displayed synchronously with the first location identifier, or may be configured to be displayed asynchronously with the first location identifier. When a display process of the first location identifier satisfies a preset condition, the first location identifier in the target map is switched to a map item identifier. The map item identifier is configured for identifying, on the target map, a location of the virtual item set in the virtual scene.

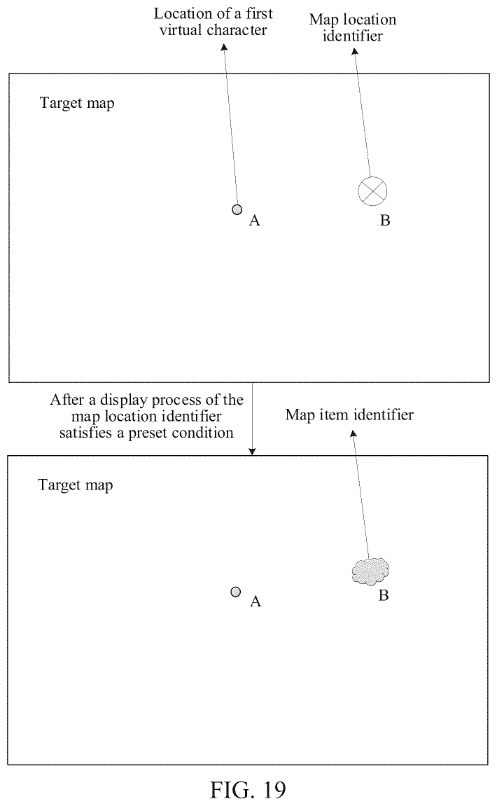

For example, FIG. 19 is a schematic diagram of still another virtual identifier processing method according to an embodiment of this application. As shown in FIG. 19, after a map location identifier configured for indicating a location of a second virtual character when being defeated is displayed on a target map, and after a display process of a map location identifier satisfies a preset condition, the map location identifier is switched to be displayed as a map item identifier. The map item identifier is displayed on the target map to indicate a location on the target map of the virtual item set dropped when the second virtual character is defeated, so that a user controlling a first virtual character may intuitively learn the location of the virtual item set dropped by the second virtual character after being defeated by viewing the target map.

As an optional solution, the method provided in this embodiment of this application further includes:

displaying text information on a social interface of the to-be-processed application if the second virtual character is defeated and the second virtual character drops the virtual item set after being defeated, the text information recording the location of the second virtual character when being defeated in the virtual scene and item information of the target virtual item in the virtual item set, and the target virtual item being the virtual item with the highest preset item level in the virtual item set;

displaying a target map in response to a second trigger operation on the text information, the target map being a map associated with the virtual scene, and an area in the virtual scene represented by the target map including an area in the virtual scene represented by the mini-map picture; and

displaying a map location identifier and/or a map item identifier on the target map, the map location identifier being configured for identifying on the target map the location of the second virtual character when being defeated in the virtual scene, and the map item identifier being configured for identifying, on the target map, the location of the virtual item set in the virtual scene.

In a possible implementation, in this embodiment of this application, the social interface of the to-be-processed application may include, but is not limited to, a friend chat interface, a team chat interface, and another social interface that allow to transmit text information, such as a chat box or a chat panel.

In a possible implementation, in this embodiment of this application, the text information is configured for indicating, in a text form, the location of the second virtual character when being defeated in the virtual scene and the item information of the target virtual item in the virtual item set. For example, a second virtual character is defeated 150 meters northeast. In this case, text information “A defeated character is found 150 meters northeast” is displayed on a chat interface to quickly inform a user on the social interface of a location of the second virtual character when being defeated. For another example, virtual item G is dropped by the second virtual character after being defeated 150 meters northeast. In this case, text information “A character is defeated 150 meters northeast and virtual item G is dropped” is displayed on the chat interface to quickly inform the user on the social interface of the location of the second virtual character when being defeated and item information of virtual item G. Virtual item G is a target virtual item with a highest preset item level in the virtual item set dropped after the second virtual character is defeated.

In a possible implementation, in this embodiment of this application, the second trigger operation is an operation for triggering display of the target map, and may be implemented by, but not limited to, performing an interaction operation on the target text information for displaying the target map. The second trigger operation may include, but is not limited to, one or more combinations of clicking/tapping, touching and holding, double clicking/tapping, a gesture, a voice, and the like. For example, the target text information is clicked/tapped to display the target map, and display the map location identifier and/or map item identifier.

This application is further described in detail with reference to the following specific examples.

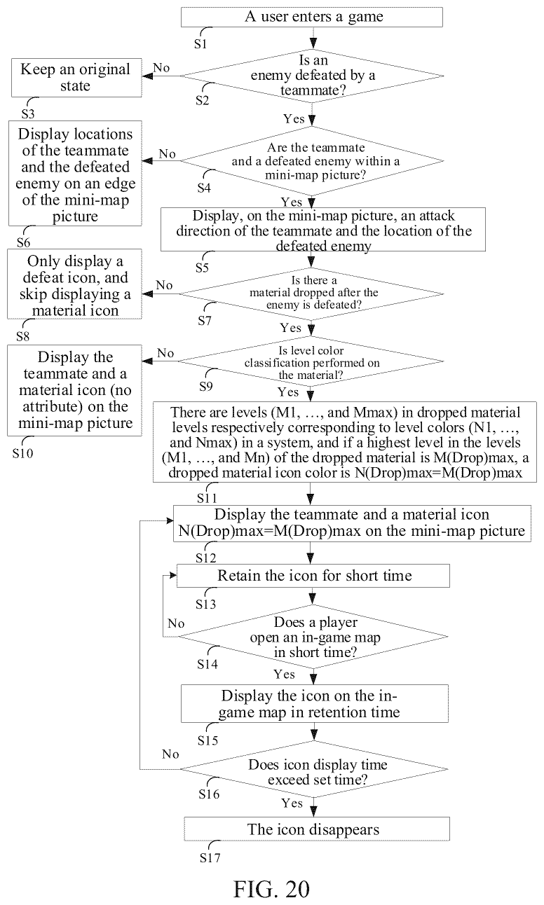

For example, FIG. 20 is a schematic diagram of still another virtual identifier processing method according to an embodiment of this application. As shown in FIG. 20, an example in which a to-be-processed application is a game application is used. Related information of a defeated virtual character (corresponding to the foregoing second virtual character) and a material (corresponding to the foregoing virtual item set) dropped after the virtual character is defeated are displayed on the mini-map picture by using the following operations.

S1: A user enters the game application.

S2: Determine whether an enemy (corresponding to the foregoing second virtual character) is defeated by a teammate of the user (corresponding to the foregoing third virtual character).

S3: Keep, if the enemy is not defeated by the teammate, an original state, and only display coordinate information (corresponding to the foregoing second location identifier) of the teammate.

S4: Determine, if the enemy is defeated by the teammate, whether the teammate and the defeated enemy are within an area corresponding to the mini-map picture.

S5: Directly display on the mini-map picture an attack direction (corresponding to the foregoing direction identifier) of the teammate and a location (corresponding to the foregoing first location identifier) of the defeated enemy if the teammate and the defeated enemy are within the mini-map picture.

S6: Display on an edge of the mini-map picture an attack direction (corresponding to the foregoing direction identifier) of the teammate and a location (corresponding to the foregoing first location identifier) of the defeated enemy if the teammate and the defeated enemy are outside the mini-map picture.

S7: Determine whether there is a material dropped after the enemy is defeated.

S8: Display, if no material is dropped after the enemy is defeated, only a defeat icon, and skip displaying a material icon.

S9: A server reads, if there is material dropped after the enemy is defeated, a material list carried by the user when being defeated, and reads an identity identifier of an item in a system and whether a level (M1, . . . , and Mn) color (N1, . . . , and Nn) classification is performed on the material.

S10: The server does not transmit, if the system does not perform the level color classification (no N1, . . . , and Nn) on the material, a corresponding level color to a client, and the material icon without an attribute is displayed.

S11: The server needs to take, if the system itself performs the level color classification (N1, . . . , and Nn) on the material, a maximum value M (Drop) max from levels (M1, . . . , and Mn) in the read material list, and after a color of M (Drop) max is read, transmits the color of M (Drop) max to the client, and the client displays a dropped material icon color N(Drop)max=M(Drop)max.

| List of | List of dropped | Level corresponding | Color corresponding |
|---|---|---|---|
| dropped | item ids read | to an item read by | to a level of an item |
| items | by the system | the system | read by the system |
| Item 1 | Item 1 id | M1 | N1 |
| Item 2 | Item 2 id | M2 | N2 |
| Item 3 | Item 3 id | M3 | N3 |

Assuming that a level-three is a maximum level, for example, a dropped box includes item 1, item 2, and item 3 simultaneously, the server obtains item levels M1, M2, and M3 after reading the ids of three items, and takes color N3 corresponding to the maximum level M3. The color is a dropped material icon color displayed by the client.

S12: Display the teammate and a material icon N(Drop)max=M(Drop)max on the mini-map picture.

S13: Retain the icon for short time.

S14: Determine whether a player opens an in-game map in short time.

S15: Display the icon on the in-game map if the user clicks/taps the in-game map during icon display time.

In addition, locations of the teammate, the defeated enemy, and the material dropped after the enemy is defeated on the in-game map can also be seen.

S16: Does the icon display time exceed set time?

S17: The icon disappears if the set time is exceeded, and S12 is performed if the set time is not exceeded.

According to this embodiment, location information of the icon displayed on the mini-map picture is simple and easy to understand. Because related information about a defeated virtual character, information about a dropped material, level information of a virtual item, and the like is information that often appears in a game, understanding costs of the user is extremely low, and the user can quickly obtain the location of the defeated virtual character and the location of the material dropped after the virtual character is defeated. During an action of the user, the user can see that another virtual character is defeated by the teammate on the mini-map picture. Simultaneously, level of the virtual item dropped after the virtual character is defeated is displayed, so that the user can efficiently view a highest level and a location of the virtual item included in the material, saving time for the user to manually search for the material and time for the teammate to mark the material. The teammate can know dropped material information without frequent mark operations, reducing some active operations of the user, so that the user can be more immersed in the game. Generally, after the enemy is defeated by the teammate, if the teammate wants to tell others where the material is or if there is a high-level material in the material, the teammate needs to perform the mark operation to tell a teammate in a distance. The teammate can also quickly learn the location of the material after being displayed on the mini-map picture without frequent marking operations, to enhance senses of accomplishment and teamwork of the user.

When the enemy is defeated by the teammate, the teammate can automatically select whether to trigger a mark. For example, when a specific second virtual character is defeated by the teammate, a pop-up window may be generated to enable the user to confirm whether to transmit related information of the defeated second virtual character to the teammate of the user. After the user confirms that the related information needs to be transmitted, a location of the second virtual character when being defeated and a dropped virtual item identifier are automatically displayed on a mini-map picture of the teammate.

In addition, the information is displayed in a display area outside the mini-map picture, such as a chat information bar, and the location of the second virtual character when being defeated and the dropped virtual item identifier are displayed in a text form, so that the user can quickly learn the location of the defeated second virtual character and the location of the dropped virtual item set.

If the user cannot get strong or favorable feedback, the defeated virtual character and the dropped virtual material (corresponding to the foregoing virtual item set) are displayed to enhance sense of achievement of the user defeating another virtual character, optimize the user experience, and improve user participation

In the specific implementation of this application, relevant data such as user information is involved. In a case that the foregoing embodiments of this application are applied to a specific product or technology, a permission or consent of a user is required, and collection, use, and processing of the relevant data need to comply with relevant laws, regulations, and standards of relevant countries and regions.

For each of the foregoing method embodiments, for ease of description, the method embodiments are described as a series of action combination. But a person of ordinary skill in the art is to know that this application is not limited to any described sequence of the action, as some operations can use other sequences or can be executed simultaneously according to this application. In addition, a person skilled in the art also knows that all embodiments described in the specification are exemplary embodiments, and the related actions and modules are not necessarily required by this application.

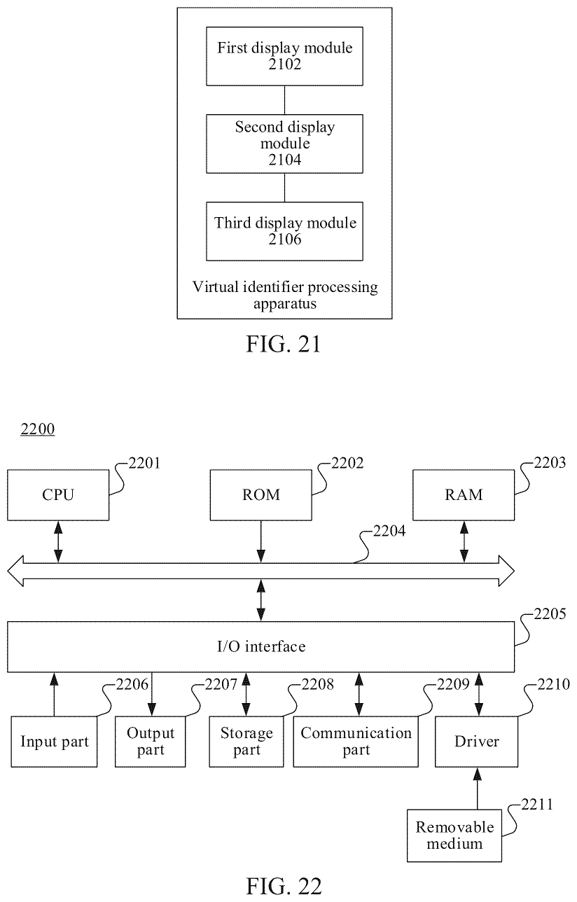

According to another aspect of embodiments of this application, a virtual identifier processing apparatus for implementing the foregoing virtual identifier processing method is further provided. As shown in FIG. 21, the apparatus includes:

a first display module 2102, configured to display, in a to-be-processed application, a virtual scene in which a first virtual character is located and a mini-map picture, the mini-map picture being a mini-map picture corresponding to the virtual scene;

a second display module 2104, configured to display a first location identifier on the mini-map picture if a second virtual character in the virtual scene is defeated, the second virtual character being a virtual character in a different camp from the first virtual character, the first location identifier being configured for identifying a location of the second virtual character when being defeated in the virtual scene, and the second virtual character being allowed to be defeated by a virtual character in a different camp in the virtual scene; and

a third display module 2106, configured to display a virtual item identifier on the mini-map picture if the second virtual character drops a virtual item set after being defeated, the virtual item identifier being configured for identifying a location of the virtual item set in the virtual scene.

As an optional solution, the apparatus is configured to display a first location identifier on the mini-map picture if a second virtual character in the virtual scene is defeated by using the following manners:

displaying a second location identifier on the mini-map picture, the second location identifier being configured for identifying a location of a third virtual character in the virtual scene, and the third virtual character being a virtual character in a same camp as the first virtual character; and

displaying the first location identifier and a direction identifier on the mini-map picture if the second virtual character is defeated by the third virtual character, the direction identifier being configured for identifying an attack direction, and the attack direction pointing from a location indicated by the second location identifier to a location indicated by the first location identifier.

As an optional solution, the apparatus is configured to display a virtual item identifier on the mini-map picture if the second virtual character drops a virtual item set after being defeated by using the following manners:

displaying the virtual item identifier within a preset range of the first location identifier if the second virtual character drops the virtual item set after being defeated, and the first location identifier is displayed on the mini-map picture; or

canceling display of the first location identifier and displaying the virtual item identifier if a display process of the first location identifier satisfies a preset condition and the second virtual character drops the virtual item set after being defeated.

As an optional solution, the apparatus is configured to cancel display of the first location identifier and displaying the virtual item identifier if a display process of the first location identifier satisfies a preset condition and the second virtual character drops the virtual item set after being defeated by using the following manners:

canceling the display of the first location identifier on the mini-map picture if display duration of the first location identifier on the mini-map picture reaches first preset duration; and

displaying the virtual item identifier on the mini-map picture if the second virtual character drops the virtual item set after being defeated, a display position of the virtual item identifier on the mini-map picture being the same as a display position of the first location identifier before the display is canceled.

As an optional solution, the apparatus is further configured to:

cancel display of the virtual item identifier on the mini-map picture if display duration of the virtual item identifier on the mini-map picture reaches second preset duration after the virtual item identifier is displayed on the mini-map picture.

As an optional solution, the apparatus is configured to display a virtual item identifier on the mini-map picture if the second virtual character drops a virtual item set after being defeated by using the following manners:

displaying the virtual item identifier having target prompt information if the second virtual character drops the virtual item set after being defeated, the target prompt information being configured for indicating that the virtual item set includes a target virtual item, and the target virtual item being a virtual item satisfying a preset condition in the virtual item set.

As an optional solution, the apparatus is configured to display the virtual item identifier having target prompt information if the second virtual character drops the virtual item set after being defeated by using the following manners:

obtaining preset item levels of virtual items in the virtual item set if the second virtual character drops the virtual item set after being defeated; and

determining a virtual item with a highest preset item level in the virtual item set as the target virtual item, and displaying the virtual item identifier having the target prompt information, the target prompt information being configured for indicating that the virtual item set includes the target virtual item with the highest preset item level.

As an optional solution, the apparatus is configured to determine a virtual item with a highest preset item level in the virtual item set as the target virtual item and displaying the virtual item identifier having the target prompt information by using the following manners:

obtaining item color information of the target virtual item, the item color information being associated with the preset item level of the target virtual item; and

displaying the virtual item identifier having the target prompt information based on the item color information, color information of the virtual item identifier being associated with the item color information of the target virtual item.

As an optional solution, the apparatus is configured to implement, by using at least one of the following manners: displaying a virtual item identifier on the mini-map picture if the second virtual character drops a virtual item set after being defeated:

displaying the virtual item identifier having first prompt information if the second virtual character drops the virtual item set after being defeated, the first prompt information being configured for indicating whether the virtual item set includes a virtual item of a preset type;

displaying the virtual item identifier having second prompt information if the second virtual character drops the virtual item set after being defeated, the second prompt information being configured for indicating a quantity of virtual items of the preset type in the virtual item set; or

displaying the virtual item identifier having third prompt information if the second virtual character drops the virtual item set after being defeated, the third prompt information being configured for indicating remaining duration that the virtual item of the preset type in the virtual item set is allowed to be obtained.

As an optional solution, the apparatus is further configured to:

display the first location identifier on a target boundary point of the mini-map picture if a location of the second virtual character when being defeated is located outside a target area, the target area being an area in the virtual scene represented by the mini-map picture, and the target boundary point being a boundary point determined based on the location of the second virtual character when being defeated relative to a direction of the target area;

display, in response to a first trigger operation on a target map, the target map, the target map being a map associated with the virtual scene, and an area in the virtual scene represented by the target map including the target area and an area in which the location of the second virtual character when being defeated is located;

display a map location identifier on the target map, the map location identifier being configured for identifying, on the target map, the location of the second virtual character when being defeated in the virtual scene; and

display a map item identifier on the target map if the second virtual character drops the virtual item set after being defeated, the map item identifier being configured for identifying, on the target map, a location of the virtual item set in the virtual scene.

As an optional solution, the apparatus is further configured to:

display text information on a social interface of the to-be-processed application if the second virtual character is defeated and the second virtual character drops the virtual item set after being defeated, the text information recording the location of the second virtual character when being defeated in the virtual scene and item information of the target virtual item in the virtual item set, and the target virtual item being the virtual item with the highest preset item level in the virtual item set;

display a target map in response to a second trigger operation on the text information, the target map being a map associated with the virtual scene, and an area in the virtual scene represented by the target map including an area in the virtual scene represented by the mini-map picture; and

display a map location identifier and/or a map item identifier on the target map, the map location identifier being configured for identifying on the target map the location of the second virtual character when being defeated in the virtual scene, and the map item identifier being configured for identifying, on the target map, the location of the virtual item set in the virtual scene.

The sequence numbers of the foregoing embodiments of this application are merely for description purpose but do not imply the preference among embodiments.

FIG. 22 is a schematic block diagram of a structure of a computer system for an electronic device for implementing an embodiment of this application.

The computer system 2200 of the electronic device shown in FIG. 22 is merely an example, and may not bring any limitation to the functions and use ranges of this embodiment of this application.

As shown in FIG. 22, the computer system 2200 includes a central processing unit (CPU) 2201, which may execute various proper actions and processing based on a program stored in a read-only memory (ROM) 2202 or a program loaded from a storage part 2208 into a random access memory (RAM) 2203. The random access memory 2203 further stores various programs and data required by system operations. The central processing unit 2201, the read-only memory 2202, and the random access memory 2203 are connected to each other through a bus 2204. An input/output interface (that is an I/O interface) 2205 is also connected to the bus 2204.

The following components are connected to the input/output interface 2205: an input part 2206 including a keyboard, a mouth, and the like; an output part 2207 including, for example, a cathode ray tube (CRT), a liquid crystal display (LCD), a speaker, and the like; a storage part 2208 including a hard disk and the like; and a communication part 2209 including a network interface card such as a local area network card or a modem. The communication part 2209 performs communication processing by using a network such as the Internet. A driver 1220 is also connected to the input/output interface 2205 as needed. A removable medium 2211, such as a magnetic disk, an optical disc, a photomagnetic disk, and a semiconductor memory, is installed on the driver 1220 as needed, so that a computer program read from the removable medium is installed into the storage part 2208 as needed.

Particularly, according to an embodiment of this application, the processes described in each method flowchart may be implemented as a computer software program. For example, according to an aspect of this application, a computer program product is provided, including a computer program carried on a computer-readable medium, and the computer program includes program code configured for performing the methods shown in the flowcharts. In such an embodiment, the computer program may be downloaded and installed from a network by using the communication part 2209 and/or may be installed from the removable medium 2211. When the computer program is executed by the central processing unit 2201, various functions defined in the system of this application are performed.

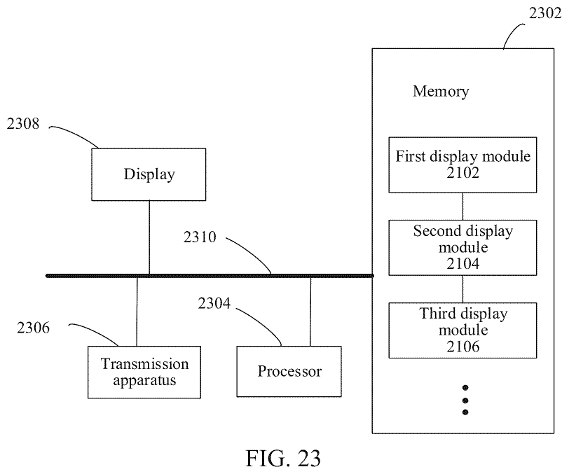

According to still another aspect in an embodiment of this application, an electronic device for implementing the foregoing virtual identifier processing method is further provided. The electronic device may be the terminal device or the server as shown in FIG. 1. In this embodiment, an example in which the electronic device is the terminal device is used for description. As shown in FIG. 23, the electronic device includes a memory 2302 and a processor 2304. The memory 2302 has a computer program stored therein, and the processor 2304 is configured to perform operations in any of the foregoing method embodiments by a computer program.

In a possible implementation, in this embodiment, the electronic device may be located in at least one of a plurality of network devices in a computer network.

In a possible implementation, a person of ordinary skill in the art may understand that the structure shown in FIG. 23 is only an example. The electronic device may be a terminal device, such as a smart phone (such as an Android mobile phone or an iOS mobile phone), a tablet computer, a palmtop computer, a mobile Internet device (MID), or a PAD. FIG. 23 does not constitute a limitation on a structure of the electronic device. For example, the electronic device may further include more or fewer components (for example, a network interface) than those shown in FIG. 23, or has a configuration different from that shown in FIG. 23.

The memory 2302 may be configured to store a software program and a module, such as a program instruction/module corresponding to the virtual identifier processing method and apparatus in embodiments of this application. The processor 2304 runs the software program and the module stored in the memory 2302, to perform various function applications and data processing, in other words, implement the foregoing virtual identifier processing method. The memory 2302 may include a high-speed random memory, and may further include a non-volatile memory, for example, one or more magnetic storage apparatuses, a flash memory, or another non-volatile solid-state memory. In some embodiments, the memory 2302 may further include memories remotely disposed relative to the processor 2304, and the remote memories may be connected to a terminal over a network. Examples of the network include, but are not limited to, the Internet, an intranet, a local area network, a mobile communication network, and a combination thereof. The memory 2302 may be specifically, but is not limited to, configured to store information such as a virtual item set. As an example, as shown in FIG. 23, the memory 2302 may include, but is not limited to, the first display module 2102, the second display module 2104, and the third display module 2106 in the virtual identifier processing apparatus. In addition, the memory may further include, but is not limited to, another module unit in the virtual identifier processing apparatus. Details are not described again in this example.

In a possible implementation, the transmission apparatus 2306 is configured to receive or transmit data over a network. Specific examples of the network may include a wired network and a wireless network. In an example, a transmission apparatus 2306 includes a network interface controller (NIC). The network interface controller may be connected to another network device and a router by using a network cable, to communicate with the Internet or a local area network. In an example, the transmission apparatus 2306 is a radio frequency (RF) module, which is configured to communicate with the Internet in a wireless manner.

In addition, the electronic device further includes: a display 2308, configured to display the foregoing mini-map picture and virtual scene; a connection bus 2310, configured to connect various module component in the foregoing electronic device.

In another embodiment, the foregoing terminal device or server may be a node in a distributed system. The distributed system may be a blockchain system, the blockchain system may be a distributed system formed by connecting a plurality of nodes through network communication. A peer to peer (P2P) network may be formed between the nodes. Any form of a computing device, such as the server, the terminal, and another electronic device, may become a node in the blockchain system by joining the peer-to-peer network.

According to an aspect of this application, a computer-readable storage medium is provided. A processor of a computer device reads a computer program from the computer-readable storage medium. The processor executes the computer program so that the computer device performs the virtual identifier processing method provided in the foregoing various optional implementations.

In a possible implementation, in this embodiment, a person of ordinary skill in the art may understand that all or some operations in the methods of the foregoing embodiments may be performed by a program instructing hardware of the terminal device. The program may be stored in a computer-readable storage medium. The storage medium may include: a flash drive, a read-only memory (ROM), a random access memory (RAM), a magnetic disk, an optical disc, and the like.

The sequence numbers of the foregoing embodiments of this application are merely for description purpose but do not imply the preference among embodiments.

When the integrated unit in the foregoing embodiments is implemented in a form of a software functional unit and sold or used as an independent product, the integrated unit may be stored in the computer-readable storage medium. Based on such understanding, the technical solutions of this application essentially, or a part contributing to related art, or all or a part of the technical solution may be implemented in a form of a software product. The computer software product is stored in a storage medium and includes several instructions for instructing one or more computer devices (which may be a personal computer, a server, a network device, or the like) to perform all or some of operations of the method in embodiments of this application.

In the foregoing embodiments of this application, the descriptions of embodiments have respective focuses. For a part that is not described in detail in an embodiment, reference is made to related descriptions in other embodiments.

In the several embodiments provided in this application, the disclosed client may be implemented in another manner. The apparatus embodiments described above are merely exemplary. For example, the division of the units is merely the division of logic functions, and may use other division manners during actual implementation. For example, a plurality of units or components may be combined, or may be integrated into another system, or some features may be omitted or not performed. In addition, the coupling, or direct coupling, or communication connection between the displayed or discussed components may be the indirect coupling or communication connection by using some interfaces, units, or modules, and may be electrical or of other forms.

The units described as separate components may or may not be physically separated, and components displayed as units may or may not be physical units, may be located in one place, or may be distributed on a plurality of network units. Some or all of the units may be selected according to actual needs to achieve the objectives of the solutions of embodiments.

In addition, functional units in embodiments of this application may be integrated into one processing unit, or each of the units may be physically separated, or two or more units may be integrated into one unit. The integrated unit may be implemented in the form of hardware, or may be implemented in a form of a software functional unit.

In sum, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module. The foregoing descriptions are merely exemplary implementations of this application. A person of ordinary skill in the art may further make various improvements and modifications without departing from the principle of this application, and the improvements and modifications fall within the protection scope of this application.

What is claimed is:

1. A virtual identifier processing method, performed by an electronic device, the method comprising:
displaying a virtual scene including a first virtual character and a mini-map picture corresponding to the virtual scene;
displaying a first location identifier on the mini-map picture where a second virtual character in the virtual scene is defeated, the second virtual character being a virtual character in a different camp from the first virtual character; and
displaying a virtual item identifier on the mini-map picture where the second virtual character drops a virtual item set after being defeated, the virtual item identifier being configured for identifying a location of the virtual item set in the virtual scene.

2. The method according to claim 1, wherein the displaying a first location identifier on the mini-map picture where a second virtual character in the virtual scene is defeated comprises:
displaying a second location identifier on the mini-map picture, the second location identifier identifying a location of a third virtual character that attacks the second virtual character in the virtual scene, and the third virtual character being a virtual character in a same camp as the first virtual character; and
displaying the first location identifier and a direction identifier on the mini-map picture, the direction identifier identifying an attack direction pointing from a location indicated by the second location identifier to a location indicated by the first location identifier.

3. The method according to claim 1, wherein the displaying a virtual item identifier on the mini-map picture where the second virtual character drops a virtual item set after being defeated comprises:
displaying the first location identifier and the virtual item identifier within a preset range of the first location identifier when the second virtual character drops the virtual item set after being defeated; or
displaying only the virtual item identifier when the first location identifier satisfies a preset condition and the second virtual character drops the virtual item set after being defeated.

4. The method according to claim 3, wherein the displaying only the virtual item identifier when the first location identifier satisfies a preset condition and the second virtual character drops the virtual item set after being defeated comprises:
canceling the display of the first location identifier on the mini-map picture when display duration of the first location identifier on the mini-map picture reaches first preset duration; and
displaying only the virtual item identifier on the mini-map picture, a display position of the virtual item identifier on the mini-map picture being the same as a display position of the first location identifier before the display is canceled.

5. The method according to claim 1, wherein the displaying a virtual item identifier on the mini-map picture where the second virtual character drops a virtual item set after being defeated comprises:
displaying the virtual item identifier having target prompt information, the target prompt information indicating that the virtual item set comprises a target virtual item satisfying a preset condition in the virtual item set.

6. The method according to claim 5, wherein the displaying the virtual item identifier having target prompt information comprises:
obtaining preset item levels of virtual items in the virtual item set;
determining a virtual item with a highest preset item level in the virtual item set as the target virtual item; and
displaying the virtual item identifier having the target prompt information, the target prompt information the virtual item set comprises the target virtual item with the highest preset item level.

7. The method according to claim 1, wherein the displaying a virtual item identifier on the mini-map picture where the second virtual character drops a virtual item set after being defeated comprises at least one of the following:
displaying the virtual item identifier having first prompt information, the first prompt information indicating whether the virtual item set comprises a virtual item of a preset type; a quantity of virtual items of the preset type in the virtual item set; or remaining duration of obtaining the virtual item of the preset type in the virtual item set.

8. The method according to claim 1, further comprising:
displaying the first location identifier on a target boundary point of the mini-map picture when the second virtual character is defeated outside the mini-map picture, and the target boundary point being a boundary point determined based on the defeating location of the second virtual character relative to a direction of the mini-map picture;
in response to a first trigger operation on a target map icon, displaying a target map comprising the mini-map picture and the defeating location of the second virtual character;
displaying a map location identifier on the target map, the map location identifier identifying the defeating location of the second virtual character; and
displaying a map item identifier on the target map where the second virtual character drops the virtual item set after being defeated, the map item identifier identifying a location of the virtual item set in the virtual scene.

9. The method according to claim 1, further comprising:
displaying text information on a social interface of the virtual scene, the text information recording the defeating location of the second virtual character in the virtual scene and item information of the target virtual item in the virtual item set;
displaying a target map in response to a second trigger operation on the text information, the target map comprising an area in the virtual scene represented by the mini-map picture; and
displaying a map location identifier and/or a map item identifier on the target map, the map location identifier identifying on the target map the defeating location of the second virtual character, and the map item identifier identifying, on the target map, the location of the virtual item set in the virtual scene.

10. An electronic device, comprising a memory and a processor, the memory having a computer program stored therein that, when executed by the processor, causes the electronic device to perform a virtual identifier processing method including:
displaying a virtual scene including a first virtual character and a mini-map picture corresponding to the virtual scene;
displaying a first location identifier on the mini-map picture where a second virtual character in the virtual scene is defeated, the second virtual character being a virtual character in a different camp from the first virtual character; and
displaying a virtual item identifier on the mini-map picture where the second virtual character drops a virtual item set after being defeated, the virtual item identifier being configured for identifying a location of the virtual item set in the virtual scene.

11. The electronic device according to claim 10, wherein the displaying a first location identifier on the mini-map picture where a second virtual character in the virtual scene is defeated comprises:
displaying a second location identifier on the mini-map picture, the second location identifier identifying a location of a third virtual character that attacks the second virtual character in the virtual scene, and the third virtual character being a virtual character in a same camp as the first virtual character; and
displaying the first location identifier and a direction identifier on the mini-map picture, the direction identifier identifying an attack direction pointing from a location indicated by the second location identifier to a location indicated by the first location identifier.

12. The electronic device according to claim 10, wherein the displaying a virtual item identifier on the mini-map picture where the second virtual character drops a virtual item set after being defeated comprises:
displaying the first location identifier and the virtual item identifier within a preset range of the first location identifier when the second virtual character drops the virtual item set after being defeated; or
displaying only the virtual item identifier when the first location identifier satisfies a preset condition and the second virtual character drops the virtual item set after being defeated.

13. The electronic device according to claim 12, wherein the displaying only the virtual item identifier when the first location identifier satisfies a preset condition and the second virtual character drops the virtual item set after being defeated comprises:
canceling the display of the first location identifier on the mini-map picture when display duration of the first location identifier on the mini-map picture reaches first preset duration; and
displaying only the virtual item identifier on the mini-map picture, a display position of the virtual item identifier on the mini-map picture being the same as a display position of the first location identifier before the display is canceled.

14. The electronic device according to claim 10, wherein the displaying a virtual item identifier on the mini-map picture where the second virtual character drops a virtual item set after being defeated comprises:
displaying the virtual item identifier having target prompt information, the target prompt information indicating that the virtual item set comprises a target virtual item satisfying a preset condition in the virtual item set.

15. The electronic device according to claim 14, wherein the displaying the virtual item identifier having target prompt information comprises:
obtaining preset item levels of virtual items in the virtual item set;
determining a virtual item with a highest preset item level in the virtual item set as the target virtual item; and
displaying the virtual item identifier having the target prompt information, the target prompt information the virtual item set comprises the target virtual item with the highest preset item level.

16. The electronic device according to claim 10, wherein the displaying a virtual item identifier on the mini-map picture where the second virtual character drops a virtual item set after being defeated comprises at least one of the following:
displaying the virtual item identifier having first prompt information, the first prompt information indicating whether the virtual item set comprises a virtual item of a preset type; a quantity of virtual items of the preset type in the virtual item set; or remaining duration of obtaining the virtual item of the preset type in the virtual item set.

17. The electronic device according to claim 10, wherein the method further comprises:
displaying the first location identifier on a target boundary point of the mini-map picture when the second virtual character is defeated outside the mini-map picture, and the target boundary point being a boundary point determined based on the defeating location of the second virtual character relative to a direction of the mini-map picture;
in response to a first trigger operation on a target map icon, displaying a target map comprising the mini-map picture and the defeating location of the second virtual character;
displaying a map location identifier on the target map, the map location identifier identifying the defeating location of the second virtual character; and
displaying a map item identifier on the target map where the second virtual character drops the virtual item set after being defeated, the map item identifier identifying a location of the virtual item set in the virtual scene.

18. The electronic device according to claim 10, wherein the method further comprises:
displaying text information on a social interface of the virtual scene, the text information recording the defeating location of the second virtual character in the virtual scene and item information of the target virtual item in the virtual item set;
displaying a target map in response to a second trigger operation on the text information, the target map comprising an area in the virtual scene represented by the mini-map picture; and
displaying a map location identifier and/or a map item identifier on the target map, the map location identifier identifying on the target map the defeating location of the second virtual character, and the map item identifier identifying, on the target map, the location of the virtual item set in the virtual scene.

19. A non-transitory computer-readable storage medium, having a computer program stored thereon that, when executed by the processor, causes the electronic device to perform a virtual identifier processing method including:
displaying a virtual scene including a first virtual character and a mini-map picture corresponding to the virtual scene;
displaying a first location identifier on the mini-map picture where a second virtual character in the virtual scene is defeated, the second virtual character being a virtual character in a different camp from the first virtual character; and
displaying a virtual item identifier on the mini-map picture where the second virtual character drops a virtual item set after being defeated, the virtual item identifier being configured for identifying a location of the virtual item set in the virtual scene.

20. The non-transitory computer-readable storage medium according to claim 19, wherein the displaying a first location identifier on the mini-map picture where a second virtual character in the virtual scene is defeated comprises:
displaying a second location identifier on the mini-map picture, the second location identifier identifying a location of a third virtual character that attacks the second virtual character in the virtual scene, and the third virtual character being a virtual character in a same camp as the first virtual character; and
displaying the first location identifier and a direction identifier on the mini-map picture, the direction identifier identifying an attack direction pointing from a location indicated by the second location identifier to a location indicated by the first location identifier.
